(19) United States
(12) Patent Application Publication
(10) Pub. No.: US 2026/0268527 A1
(43) Pub. Date: Sep. 10, 2026

(54) ENCODING APPARATUS, ENCODING SYSTEM, ENCODING METHOD, AND ENCODING PROGRAM

(71) Applicant: Sony Semiconductor Solutions Corporation, Kanagawa (JP)

(72) Inventors: Kazuya Ogawa, Tokyo (JP); Satoshi Mitsuhashi, Tokyo (JP); Tsuyoshi Kimura, Kanagawa (JP)

(21) Appl. No.: 19/167,914

(22) PCT Filed: Apr. 30, 2024
(86) PCT No.: PCT/JP2024/016626

§ 371 Date: Sep. 23, 2025

(30) Foreign Application Priority Data
May 11, 2023 (JP) 2023-078517

(51) Int. Cl. G06T 9/00

(52) U.S. Cl. CPC G06T 9/00

(57) ABSTRACT

To enable improvement of encoding efficiency. An encoding apparatus includes: an input receiving unit that receives an input of a plurality of pieces of point cloud data; a determination unit that determines a spatial quantization value of each of the plurality of pieces of point cloud data based on at least one of a resolution and a density of each of the plurality of pieces of point cloud data an input of which has been received by the input receiving unit; and an encoding unit that encodes each of the plurality of pieces of point cloud data based on the spatial quantization value determined by the determination unit.

### FIELD

The present invention relates to an encoding apparatus, an encoding system, an encoding method, and an encoding program.

### BACKGROUND

There are known techniques of encoding point cloud data (refer to Patent Literatures 1 to 3, for example). Examples of the known techniques of encoding point cloud data include a technique of compressing 3D point cloud data such as a mesh or a point cloud representing topographic data, a building structure, a civil engineering structure, or the like as a three-dimensional (3D) structure. Examples of the technique of compressing 3D point cloud data such as a point cloud include Geometry-based Point Cloud Compression (G-PCC) and Video-based Point Cloud Compression (V-PCC), standardized by Moving Picture Experts Group (MPEG) (refer to Non Patent Literature 1, for example).

For example, the G-PCC represents a method of dividing a space to be encoded including point cloud data in compression processing of 3D point cloud data into voxel data having a uniform size, performing spatial quantization on the voxel data, then dividing the voxel data into octree structure data having a recursive octree structure, and encoding the octree structure data.

### CITATION LIST

### Patent Literature

Patent Literature 1: WO 2020/071116 A
Patent Literature 2: WO 2019/078000 A

### Patent Literature 3: WO 2020/162495 A

### Non Patent Literature

Non Patent Literature 1: ISO/IEC JTC 1/SC 29/WG 11 N18189 “G-PCC codec description v2”

### SUMMARY

### Technical Problem

However, there is a case where the above-described technology cannot improve encoding efficiency. For example, when encoding a plurality of pieces of point cloud data, applying a same spatial quantization value to all the point cloud data would quantize low resolution point cloud data in a spatial direction with higher precision than necessary, leading to a decrease in encoding efficiency. One aspect of the present disclosure is to enable improvement in encoding efficiency.

### Solution to Problem

An encoding apparatus according to one aspect of the present disclosure includes an input receiving unit that receives an input of a plurality of pieces of point cloud data, a determination unit that determines a spatial quantization value of each of the plurality of pieces of point cloud data based on at least one of a resolution and a density of each of the plurality of pieces of point cloud data an input of which has been received by the input receiving unit, and an encoding unit that encodes each of the plurality of pieces of point cloud data based on the spatial quantization value determined by the determination unit.

An encoding system according to one aspect of the present disclosure includes an encoding apparatus and a reproduction apparatus, wherein the encoding apparatus includes, an input receiving unit that receives an input of a plurality of pieces of point cloud data, a determination unit that determines a spatial quantization value of each of the plurality of pieces of point cloud data based on at least one of a resolution and a density of each of the plurality of pieces of point cloud data an input of which has been received by the input receiving unit, and an encoding unit that encodes each of the plurality of pieces of point cloud data based on the spatial quantization value determined by the determination unit, and the reproduction apparatus includes a request unit that requests a reproduction target to be reproduced by the reproduction apparatus, among the plurality of pieces of point cloud data encoded by the encoding unit.

An encoding method according to one aspect of the present disclosure executed by an encoding apparatus, the encoding method comprising, an input receiving step of receiving an input of a plurality of pieces of point cloud data, a determination step of determining a spatial quantization value of each of the plurality of pieces of point cloud data based on at least one of a resolution and a density of each of the plurality of pieces of point cloud data an input of which has been received by the input receiving step, and an encoding step of encoding each of the plurality of pieces of point cloud data based on the spatial quantization value determined by the determination step.

An encoding program according to one aspect of the present disclosure causes a computer mounted on an encoding apparatus to execute, input receiving processing of receiving an input of a plurality of pieces of point cloud data, determination processing of determining a spatial quantization value of each of the plurality of pieces of point cloud data based on at least one of a resolution and a density of each of the plurality of pieces of point cloud data an input of which has been received by the input receiving processing, and encoding processing of encoding each of the plurality of pieces of point cloud data based on the spatial quantization value determined by the determination processing.

### BRIEF DESCRIPTION OF DRAWINGS

FIG. 1 is a diagram illustrating an example of a schematic configuration of an encoding system according to a first embodiment.

FIG. 2 is a diagram for illustrating the encoding system according to the first embodiment.

FIG. 3 is a diagram for illustrating the encoding system according to the first embodiment.

FIG. 4 is a diagram for illustrating the encoding system according to the first embodiment.

FIG. 5 is a diagram illustrating an example of a configuration of a control unit of an encoding apparatus according to the first embodiment.

FIG. 6 is a diagram for illustrating the encoding apparatus according to the first embodiment.

FIG. 7 is a diagram for illustrating the encoding apparatus according to the first embodiment.

FIG. 8 is a diagram for illustrating the encoding apparatus according to the first embodiment.

FIG. 9 is a diagram for illustrating the encoding apparatus according to the first embodiment.

FIG. 10 is a flowchart illustrating an example of processing of the encoding apparatus according to the first embodiment.

FIG. 11 is a flowchart illustrating an example of processing of the encoding apparatus according to the first embodiment.

FIG. 12 is a flowchart illustrating an example of processing of the encoding apparatus according to the first embodiment.

FIG. 13 is a flowchart illustrating an example of processing of the encoding apparatus according to the first embodiment.

FIG. 14 is a flowchart illustrating an example of processing of the encoding apparatus according to the first embodiment.

FIG. 15 is a flowchart illustrating an example of processing of a reproduction apparatus according to the first embodiment.

FIG. 16 is a flowchart illustrating an example of processing of the reproduction apparatus according to the first embodiment.

FIG. 17 is a flowchart illustrating an example of processing of the reproduction apparatus according to the first embodiment.

FIG. 18 is a flowchart illustrating an example of processing of the reproduction apparatus according to the first embodiment.

FIG. 19 is a flowchart illustrating an example of processing of the reproduction apparatus according to the first embodiment.

FIG. 20 is a flowchart illustrating an example of processing of the reproduction apparatus according to the first embodiment.

FIG. 21 is a diagram illustrating an example of a schematic configuration of an encoding system according to a second embodiment.

FIG. 22 is a diagram illustrating an example of a configuration of a control unit of an encoding apparatus according to the second embodiment.

FIG. 23 is a diagram illustrating an example of a hardware configuration of the apparatus.

FIG. 24 is a diagram illustrating an example of a schematic configuration of an encoding apparatus according to a reference technology.

FIG. 25 is a diagram for illustrating the encoding apparatus according to the reference technology.

FIG. 26 is a diagram for illustrating the encoding apparatus according to the reference technology.

FIG. 27 is a diagram illustrating an example of a configuration of a control unit of the encoding apparatus according to the reference technology.

### DESCRIPTION OF EMBODIMENTS

Embodiments of the present disclosure will be described below in detail with reference to the drawings. In the following embodiments, the same elements may be denoted by the same reference symbols to omit a repetitive description.

The present disclosure will be described in the following order of items.
0. Introduction
1. First Embodiment
2. Second Embodiment
3. Hardware configuration example
4. Exemplary effects

### 0. INTRODUCTION

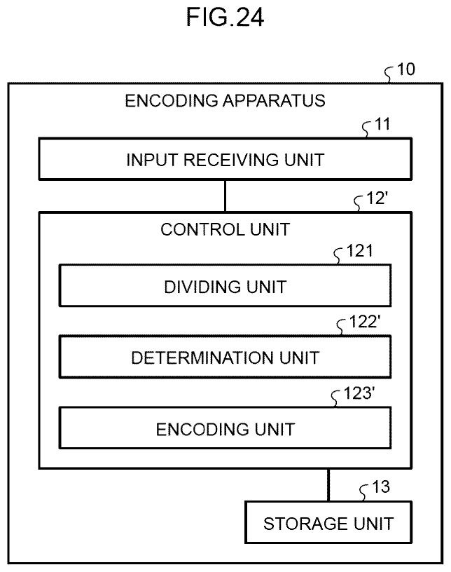

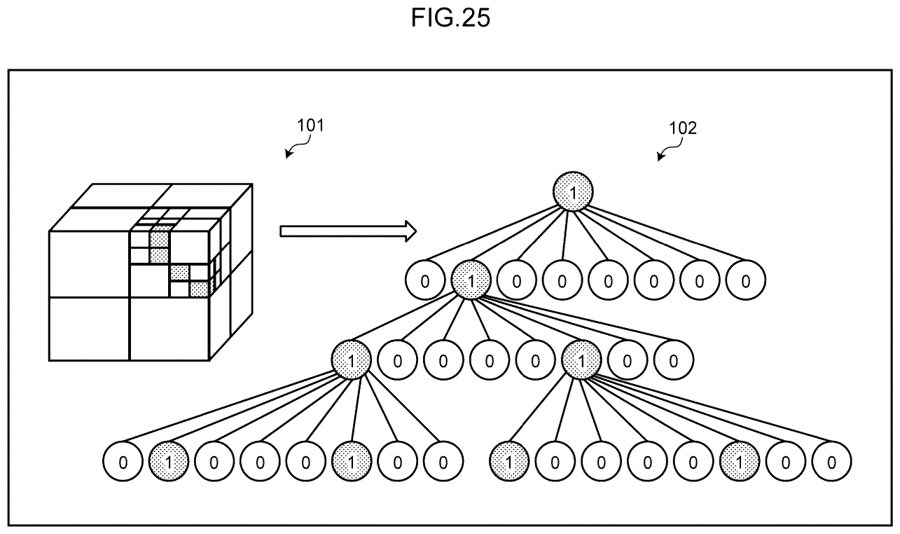

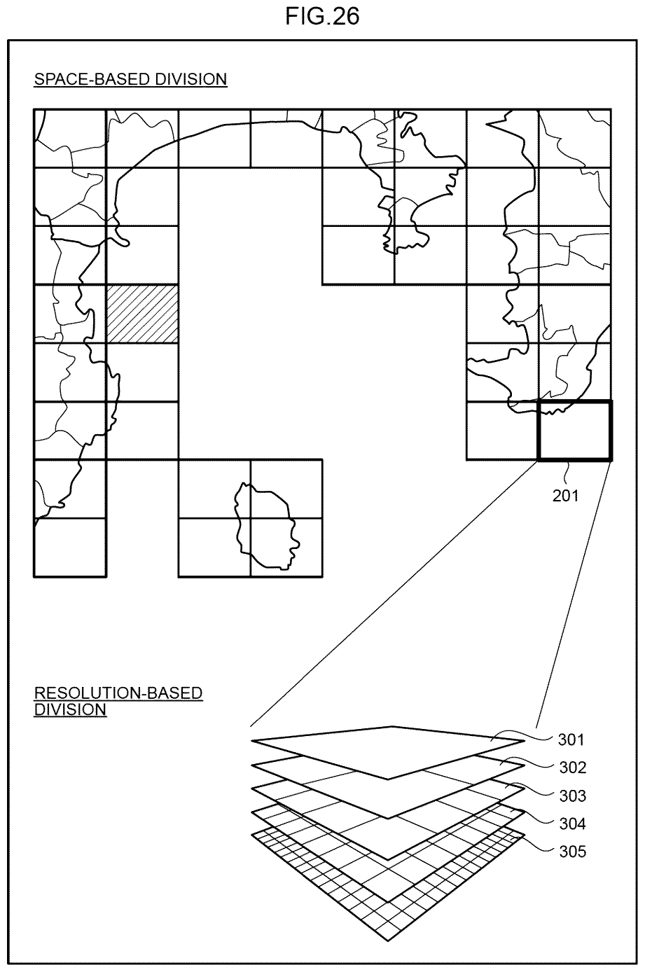

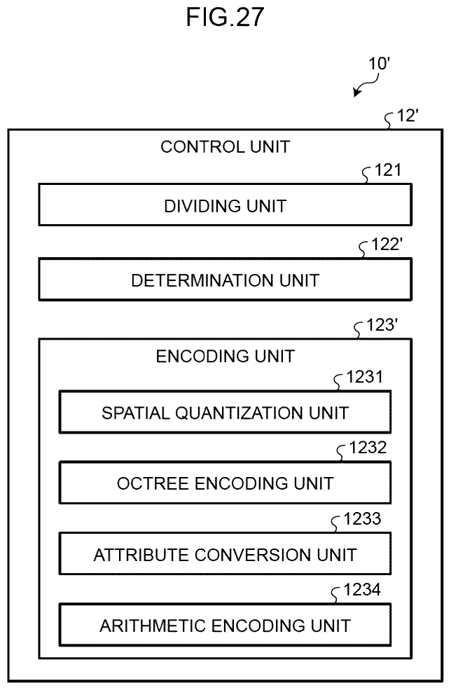

As described above, examples of the technology of encoding point cloud data include a technology of compressing three-dimensional (3D) point cloud data such as Geometry based compression approach (G-PCC). Before describing the embodiment of the present disclosure, an example of a reference technology related to the technology of compressing 3D point cloud data using G-PCC will be described with reference to FIGS. 24 to 27. FIG. 24 is a diagram illustrating an example of a schematic configuration of an encoding apparatus according to a reference technology. FIGS. 25 and 26 are diagrams for illustrating the encoding apparatus according to the reference technology. FIG. 27 is a diagram illustrating an example of a configuration of a control unit of the encoding apparatus according to the reference technology.

An encoding apparatus 10′ illustrated in FIG. 24 encodes point cloud data. As described above, in the example illustrated in FIG. 24, the encoding apparatus 10′ is a reference technology related to the technology of compressing 3D point cloud data using G-PCC, and thus, encodes 3D point cloud data. However, the point cloud data is not particularly limited as long as it is point cloud data in a predetermined space, and may be 2D point cloud data in a 2D space, for example. Accordingly, the encoding apparatus 10′ may encode 2D point cloud data. Examples of the encoding apparatus 10′ include a cloud and a terminal. Hereinafter, an outline of the encoding apparatus 10′ will be described with reference to FIG. 25.

The encoding apparatus 10′ divides a space to be encoded including point cloud data into voxel data of a uniform size. After performing spatial quantization of voxel data, the encoding apparatus 10′ divides the data into octree structure data 101 having a recursive octree structure illustrated in FIG. 25, performs arithmetic encoding processing on the octree structure data 101, and converts the data into binary data 102 represented in a binary format illustrated in FIG. 25. With this operation, the encoding apparatus 10′ stores (preserves) the binary data 102 as encoded point cloud data (compressed point cloud data) such as a bit stream. Next, returning to FIG. 24, an example of a configuration of the encoding apparatus 10′ will be described. In the example illustrated in FIG. 24, the encoding apparatus 10′ includes an input receiving unit 11 and a control unit 12′.

The input receiving unit 11 receives an input of a plurality of pieces of point cloud data. In the example illustrated in FIG. 24, the input receiving unit 11 receives an input of a plurality of pieces of point cloud data including 3D point cloud data. The input receiving unit 11 may receive an input of a plurality of pieces of point cloud data including 2D point cloud data. The input receiving unit 11 is not particularly limited as long as it receives an input of a plurality of pieces of point cloud data. Examples of the input receiving unit 11 include a User Interface (UI) such as a button displayed on a display unit such as a desktop or a touch panel of a personal computer.

The control unit 12′ performs overall control of the encoding apparatus 10′. For example, the control unit 12′ includes one or more processors having internal memory storing a program defining each processing procedure and storing control data, and the processor executes each processing using the program and the internal memory. Examples of the control unit 12′ include: electronic circuits such as a Central Processing Unit (CPU), a Micro Processing Unit (MPU), and a Graphics Processing Unit (GPU); and integrated circuits such as an Application Specific Integrated Circuit (ASIC) and a Field Programmable Gate Array (FPGA). In the example illustrated in FIG. 24, the control unit 12′ includes a dividing unit 121, a determination unit 122′, and an encoding unit 123′.

The dividing unit 121 divides each of the plurality of pieces of point cloud data into a plurality of pieces of divided point cloud data based on at least one of a space including each of the plurality of pieces of point cloud data and a resolution of each of the plurality of pieces of point cloud data. For example, the dividing unit 121 divides a space including each of the plurality of pieces of point cloud data into a plurality of divided spaces, thereby dividing each of the plurality of pieces of point cloud data into a plurality of pieces of divided point cloud data. In other cases, the dividing unit 121 divides each of the plurality of pieces of point cloud data into a plurality of pieces of divided point cloud data based on a resolution level of each of the plurality of pieces of point cloud data.

Hereinafter, an example of division performed by the dividing unit 121 will be described with reference to FIG. 26. As illustrated in the space-based division diagram of FIG. 26, the dividing unit 121 divides a space including each of the plurality of pieces of point cloud data into a plurality of divided spaces such as a plurality of tiles 201, each being a tile of 100 meters square, thereby dividing each of the plurality of pieces of point cloud data into a plurality of pieces of divided point cloud data. Subsequently, as illustrated in the resolution-based division diagram of FIG. 26, the dividing unit 121 divides each of the plurality of pieces of divided point cloud data into a plurality of pieces, namely, divided point cloud data 301 to 305, for each resolution of each of the plurality of pieces of divided point cloud data.

In the example illustrated in the resolution-based division diagram of FIG. 26, the dividing unit 121 divides each of the plurality of pieces of divided point cloud data into five pieces of divided point cloud data, namely, divided point cloud data 301 being low resolution level data to divided point cloud data 305 being high resolution level data. However, the number of divisions based on the resolution by the dividing unit 121 is not particularly limited, and may be, for example, three or more of divided point cloud data being low resolution level data, divided point cloud data being medium resolution level data, and divided point cloud data being high resolution level data. Similarly, the number of divisions based on the space by the dividing unit 121 is not particularly limited.

The determination unit 122′ determines the spatial quantization value of each of the plurality of pieces of point cloud data an input of each of which has been received by the input receiving unit 11. The spatial quantization value represents a value for determining quantization precision when a plurality of pieces of point cloud data in a predetermined space is quantized in the spatial direction. For example, in a case where 3D point cloud data is included in a plurality of pieces of point cloud data, the spatial quantization value represents a value for determining the quantization precision when the 3D point cloud data in the 3D space is quantized in the spatial direction. In a case where 2D point cloud data is included in a plurality of pieces of point cloud data, the spatial quantization value represents a value for determining the quantization precision when the 2D point cloud data in the 2D space is quantized in the spatial direction. In the example illustrated in FIG. 24, the determination unit 122′ determines the spatial quantization value of each of the plurality of pieces of divided point cloud data divided by the dividing unit 121 to be the same value. For example, the determination unit 122′ determines the spatial quantization value of each of the plurality of pieces of divided point cloud data 301 to 305 illustrated in FIG. 26 to be the same value.

The encoding unit 123′ encodes each of the plurality of pieces of point cloud data based on the spatial quantization value determined by the determination unit 122′. In the example illustrated in FIG. 24, the encoding unit 123′ encodes each of the plurality of pieces of divided point cloud data based on the spatial quantization value of each of the plurality of pieces of divided point cloud data divided by the dividing unit 121. As an example, since the spatial quantization value of each of the plurality of pieces of divided point cloud data 301 to 305 illustrated in FIG. 26 is determined to be the same value by the determination unit 122′, the encoding unit 123′ encodes each of the plurality of pieces of divided point cloud data 301 to 305 with the same precision. Hereinafter, the configuration of the encoding unit 123′ will be described with reference to FIG. 27. In the example illustrated in FIG. 27, the encoding unit 123′ includes a spatial quantization unit 1231, an octree encoding unit 1232, an attribute conversion unit 1233, and an arithmetic encoding unit 1234.

The spatial quantization unit 1231 quantizes each of the plurality of pieces of divided point cloud data divided by the dividing unit 121. For example, using the spatial quantization value of each of the plurality of pieces of divided point cloud data, the spatial quantization unit 1231 quantizes spatial position information of each of the plurality of pieces of divided point cloud data (performing rounding processing to lattice points) to convert each of the plurality of pieces of divided point cloud data into voxel data.

The octree encoding unit 1232 converts the voxel data converted by the spatial quantization unit 1231 into octree structure data. For example, the octree encoding unit 1232 converts the voxel data converted by the spatial quantization unit 1231 into the octree structure data 101 illustrated in FIG. 25.

In a case where the octree structure data divided by the octree encoding unit 1232 is attribute data with attributes such as color information, the attribute conversion unit 1233 converts the format or the like of the attribute included in the attribute data.

The arithmetic encoding unit 1234 performs arithmetic encoding processing on the octree structure data converted by the octree encoding unit 1232 or the attribute data having the format of the attribute or the like converted by the attribute conversion unit 1233. For example, as illustrated in FIG. 25, the arithmetic encoding unit 1234 performs arithmetic encoding processing on the octree structure data 101 to convert the data into binary data 102. The arithmetic encoding unit 1234 stores the binary data 102 in a storage unit 13 as encoded point cloud data such as a bit stream.

Returning to the description of FIG. 24. The storage unit 13 stores various data such as a plurality of pieces of point cloud data, a plurality of pieces of divided point cloud data, and a plurality of pieces of encoded point cloud data such as a plurality of pieces of encoded divided point cloud data, an operating system (OS), and various programs. For example, the storage unit 13 stores each of the plurality of encoded (compressed) point cloud data for each resolution (resolution level). Examples of the storage unit 13 include a storage apparatus such as a Hard Disk Drive (HDD), a Solid State Drive (SSD), and an optical disk, and semiconductor memory capable of rewriting data, such as Random Access Memory (RAM), flash memory, and Non Volatile Static Random Access Memory (NVSRAM).

Meanwhile, in order to achieve a higher rate in display, processing, and operation of large-scale 3D point cloud data such as terrain data, it is conceivable to display the entire space as data obtained by space-based division and data obtained as resolution-based division as illustrated in FIG. 26, rather than one large-scale point cloud data. This makes it possible to extract point cloud data of the necessary resolution of the necessary spatial region.

However, the reference technology as described above may not be able to improve the encoding efficiency. For example, as illustrated in the diagram of the resolution-based division in FIG. 26, in a case where the same spatial quantization value is applied to the plurality of pieces of divided point cloud data 301 to 305 of all the hierarchies when encoding the plurality of pieces of divided point cloud data divided for each resolution, the low resolution point cloud data would be quantized in the spatial direction with higher precision than necessary, leading to a problem of a decrease in encoding efficiency.

The present disclosure, in one aspect, has been made in view of this problem, and enables improvement in encoding efficiency. Specific techniques are described in the following embodiments.

### 1. FIRST EMBODIMENT

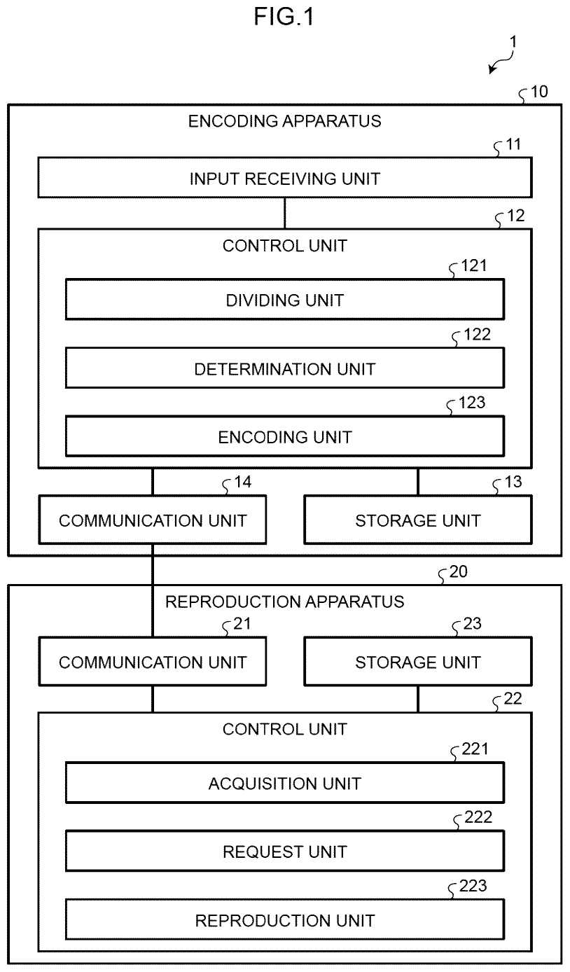

FIG. 1 is a diagram illustrating an example of a schematic configuration of an encoding system according to a first embodiment. An encoding system 1 receives an input of a plurality of pieces of point cloud data, determines a spatial quantization value of each of the plurality of pieces of point cloud data based on at least one of a resolution and a density of each of the plurality of pieces of point cloud data, and encodes each of the plurality of pieces of point cloud data based on the determined spatial quantization value. Since the point cloud data and the spatial quantization value are similar to those of the reference technology described above, the description thereof will be omitted.

The encoding system 1 includes: an encoding apparatus 10 that receives an input of a plurality of pieces of point cloud data and performs recording system processing such as encoding processing on the plurality of pieces of point cloud data an input of which has been received; and a reproduction apparatus 20 that requests a reproduction target among the encoded point cloud data from the encoding apparatus 10, decodes the reproduction target received from the encoding apparatus 10, and reproduces the reproduction target. That is, the encoding system 1 is a system in which the encoding apparatus 10 and the reproduction apparatus 20 operate in cooperation.

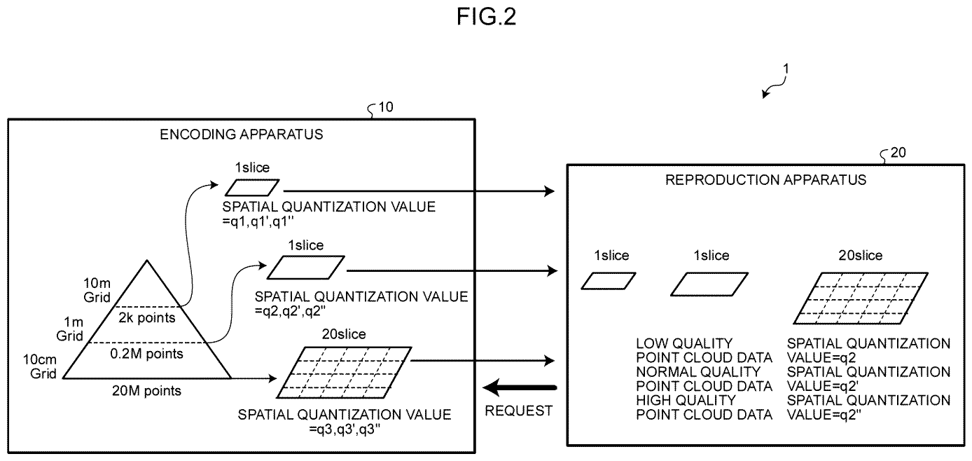

First, an outline of the encoding system 1 will be described with reference to FIGS. 2 to 4. FIGS. 2 to 4 are diagrams for illustrating the encoding system according to the first embodiment.

In the example illustrated in FIG. 2, the encoding apparatus 10 receives an input of a plurality of pieces of point cloud data. The encoding apparatus 10 divides each of the plurality of pieces of point cloud data into a plurality of pieces of divided point cloud data, that is, 1 slice of 2 k points, 1 slice of 0.2M points, and 20 slices of 20M points, based on the space including each of the plurality of pieces of point cloud data and based on the resolution of each of the plurality of pieces of point cloud data. The encoding apparatus 10 determines a spatial quantization value of each of the plurality of pieces of divided point cloud data based on at least one of the resolution and the density of each of the plurality of pieces of divided point cloud data. For example, the encoding apparatus 10 determines a spatial quantization value of 1 slice of 2 k points to be q1, q1′, or q1″ in a relationship of q1>q1′>q1″. The encoding apparatus 10 determines a spatial quantization value of 1 slice of 0.2M points to be q2, q2′, or q2″ in a relationship of q2>q2′>q2″. The encoding apparatus 10 determines the 20 slices spatial quantization value of 20M points to be q3, q3′, or q3″ in a relationship of q3>q3′>q3″ for every 1 slice.

The encoding apparatus 10 encodes each of the plurality of pieces of divided point cloud data based on the determined spatial quantization value of each of the plurality of pieces of divided point cloud data. Based on the request from the reproduction apparatus 20, the encoding apparatus 10 determines a reproduction target to be reproduced by the reproduction apparatus 20 among the plurality of encoded point cloud data.

In the example illustrated in FIG. 2, the reproduction apparatus 20 requests a reproduction target to be reproduced by the reproduction apparatus 20 among the plurality of pieces of point cloud data encoded by the encoding apparatus 10. For example, the reproduction apparatus 20 acquires at least one of communication information, region information, and the viewpoint information. In a case where a range indicated by the acquired information among these pieces of information is within a predetermined range, the reproduction apparatus 20 requests a reproduction target having a smaller spatial quantization value than a case where the range is not within the predetermined range. The communication information refers to information related to communication between the encoding apparatus 10 and the reproduction apparatus 20. The communication information may include communication band information related to a communication band between the encoding apparatus 10 and the reproduction apparatus 20, such as a communicable band of a network link enabling communication between the encoding apparatus 10 and the reproduction apparatus 20. The region information refers to information related to a region in which a reproduction target requested by the reproduction apparatus 20 is reproduced. The viewpoint information refers to information related to a viewpoint in which the reproduction target is reproduced by the reproduction apparatus 20. The viewpoint information may include information related to a visual field, camera parameters, and the like in addition to the viewpoint.

As an example, in a case where the range indicated by the acquired information among the communication information, the region information, and the viewpoint information is within a predetermined range, the reproduction apparatus 20 requests, as the reproduction target, high quality point cloud data having the spatial quantization value of q2″ smaller than q2 and q2′. In a case where the range of the acquired information among the communication information, the region information, and the viewpoint information is not within the predetermined range, the reproduction apparatus 20 requests, as the reproduction target, normal quality point cloud data having a spatial quantization value of q2′ larger than q2″ or low quality point cloud data having a spatial quantization value of q2 larger than q2′.

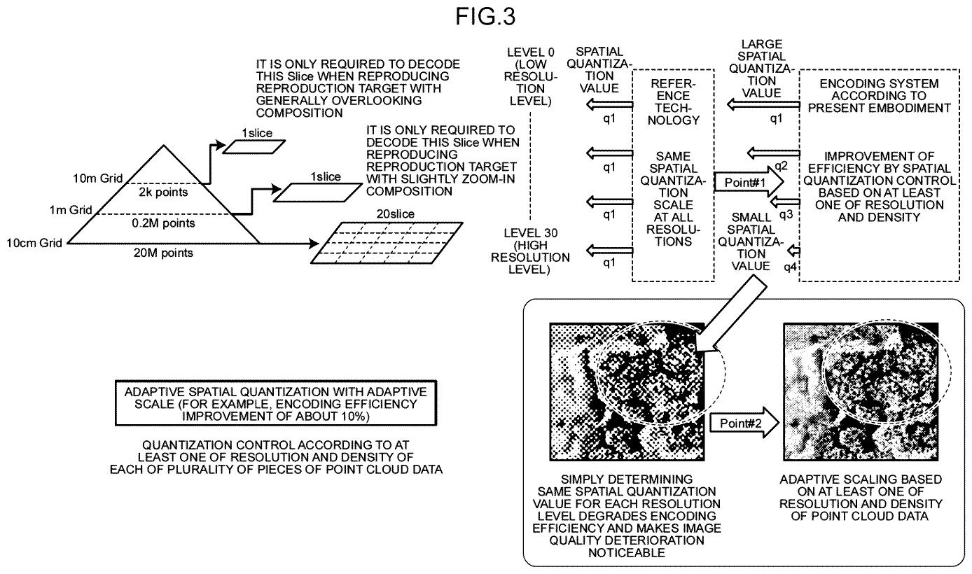

In the example illustrated in FIG. 3, the reference technology applies the point cloud data structure of the same spatial quantization scale at all resolution levels from the point cloud data of the level 0 (low resolution level) to the level 30 (high resolution level) so as to simply determine the same spatial quantization value for each resolution level. Simply determining the spatial quantization value of each of the plurality of pieces of point cloud data to be the same spatial quantization value for each resolution level in this manner might decrease the encoding efficiency, making subjective image quality deterioration noticeable in some cases.

In contrast, the encoding system 1 according to the present embodiment performs quantization control of determining the spatial quantization value based on at least one of the resolution and the density of each of the plurality of pieces of point cloud data, enabling improvement of encoding efficiency. For example, in addition to the function of the GPCC, the encoding system 1 performs adaptive spatial quantization achieved by an adaptive scale using a data structure of point cloud data divided for each resolution and to which a different spatial quantization scale (adaptive scale) is applied. This enables the encoding system 1 to improve the encoding efficiency. For example, the encoding system 1 can improve the encoding efficiency by about 10%.

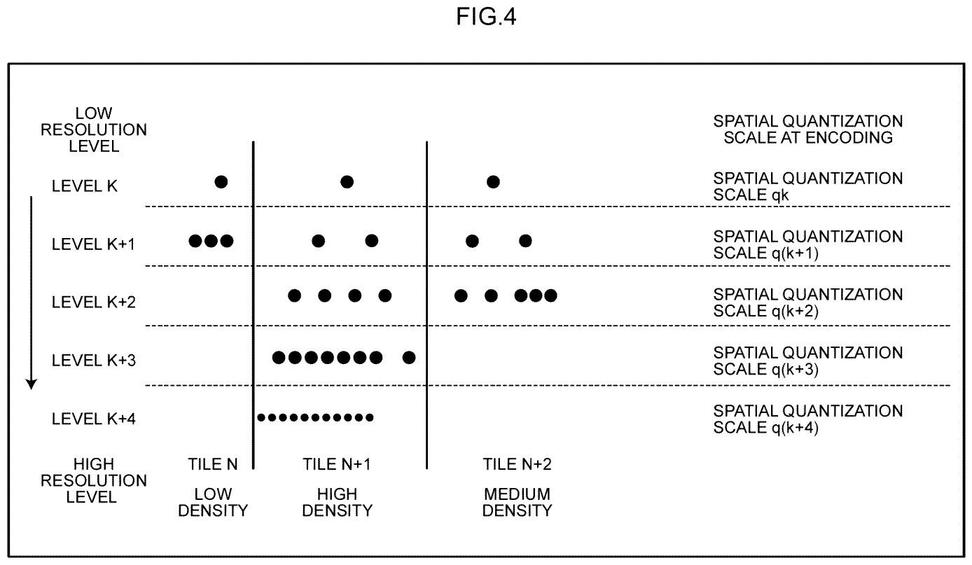

As an example, as illustrated in FIG. 4, the encoding system 1 allocates different spatial quantization scales for each resolution level of the plurality of pieces of divided point cloud data divided based on the space (tile) including each of the plurality of pieces of point cloud data and based on the resolution (resolution level) of each of the plurality of pieces of point cloud data. A tile N is low density point cloud data, a tile N+1 is high density point cloud data, and a tile N+2 is medium density point cloud data. In addition, the encoding system 1 represents data obtained by dividing each of the plurality of pieces of point cloud data of the tiles N to N+2 based on the resolutions of the levels K to K+4, as a plurality of pieces of divided point cloud data included in a part of the divided space, being a space divided into 5×3 squares. That is, the plurality of pieces of divided point cloud data are data divided into resolutions classified in five levels and into three spaces, and each of the plurality of pieces of divided point cloud data is represented as a filled point cloud in a part of the divided space divided into 5×3 squares. One piece of point data included in the point cloud data is represented as one filled point.

The encoding system 1 performs encoding processing (compression processing) on each of the plurality of pieces of divided point cloud data. In the example illustrated in FIG. 4, the encoding system 1 allocates, to a plurality of pieces of divided point cloud data having a resolution level of level K, a spatial quantization scale qk as a spatial quantization scale corresponding to the level K as a spatial quantization scale at the time of encoding (at the time of compression). The spatial quantization scale represents a degree of magnitude for determining quantization precision when a plurality of pieces of point cloud data in a predetermined space is quantized in the spatial direction. The spatial quantization scale includes a spatial quantization value, for example. That is, the spatial quantization value is one of the spatial quantization scales. The encoding system 1 allocates, to a plurality of pieces of divided point cloud data of level K+1, a spatial quantization scale q(k+1) as a spatial quantization scale according to the level Kil. The encoding system 1 allocates, to a plurality of pieces of divided point cloud data of level K+2, a spatial quantization scale q(k+2) as a spatial quantization scale according to the level K+2. The encoding system 1 allocates, to a plurality of pieces of divided point cloud data of level K+3, a spatial quantization scale q(k+3) as a spatial quantization scale according to the level K+3. The encoding system 1 allocates, to a plurality of pieces of divided point cloud data of level K+4, a spatial quantization scale q(k+4) as a spatial quantization scale according to the level K+4. Here, the spatial quantization scale is supposed to satisfy

$$q ( k + 4 ) < q ( k + 3 ) < q ( k + 2 ) < q ( k + 1 ) < qk .$$

In this manner, the encoding system 1 allocates a smaller spatial quantization scale to high-definition point cloud data at the high resolution level, and allocates a larger spatial quantization scale to low-definition point cloud data at the low resolution level. This makes it possible for the encoding system 1 to encode each of the plurality of pieces of point cloud data with an appropriate spatial quantization scale corresponding to each resolution level. As a result, the encoding system 1 can improve the image quality of the point cloud data at the high resolution level, reduce the overall amount of encoding processing with no unnecessarily high precision encoding on the point cloud data at the low resolution level, making it possible to improve the encoding efficiency while maintaining the subjective image quality. Note that, as illustrated in FIG. 4, the point data included in the point cloud data may be distributed uniformly (at equal intervals) or need not be distributed uniformly at each resolution level.

Next, returning to FIG. 1, the configuration of the encoding apparatus 10 will be described. In the example illustrated in FIG. 1, the encoding apparatus 10 includes a control unit 12 instead of the control unit 12′ of the encoding apparatus 10′ according to the reference technology, and further includes a storage unit 13 and a communication unit 14.

The control unit 12 includes a determination unit 122 and an encoding unit 123 instead of the determination unit 122′ and the encoding unit 123′ in the control unit 12′ according to the reference technology. Except for this point, the control unit 12 is similar to the control unit 12′ according to the reference technology.

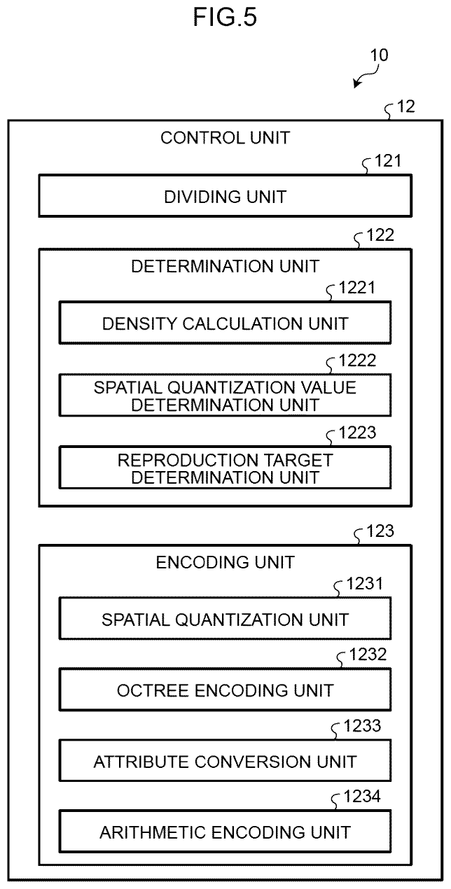

The determination unit 122 determines the spatial quantization value of each of the plurality of pieces of point cloud data based on at least one of the resolution and the density of each of the plurality of pieces of point cloud data an input of which has been received by the input receiving unit 11. In the example illustrated in FIG. 1, the determination unit 122 determines the spatial quantization value of each of the plurality of pieces of divided point cloud data based on at least one of the resolution and the density of each of the plurality of pieces of divided point cloud data divided by the dividing unit 121. An example of a configuration of the determination unit 122 will be described below with reference to FIG. 5. FIG. 5 is a diagram illustrating an example of a configuration of a control unit of the encoding apparatus according to the first embodiment. In the example illustrated in FIG. 5, the determination unit 122 includes a density calculation unit 1221, a spatial quantization value determination unit 1222, and a reproduction target determination unit 1223.

The density calculation unit 1221 calculates the density of each of the plurality of pieces of point cloud data. In this case, the density calculation unit. 1221 calculates the density of the point cloud data in the predetermined space for each of the plurality of pieces of point cloud data, thereby calculating the density of each of the plurality of pieces of point cloud data. As an example, the density calculation unit 1221 calculates the density of each of the plurality of pieces of point cloud data an input of which has been received by the input receiving unit 11. As another example, the density calculation unit 1221 calculates the density of each of the plurality of pieces of divided point cloud data divided by the dividing unit 121.

The spatial quantization value determination unit 1222 determines the spatial quantization value of each of the plurality of pieces of point cloud data based on at least one of the resolution of each of the plurality of pieces of point cloud data an input of which has been received by the input receiving unit 11 and the density calculated by the density calculation unit 1221. In the example illustrated in FIG. 1, the spatial quantization value determination unit 1222 determines the spatial quantization value of each of the plurality of pieces of divided point cloud data based on at least one of the resolution of each of the plurality of pieces of divided point cloud data divided by the dividing unit 121 and the density calculated by the density calculation unit 1221.

As an example, the spatial quantization value determination unit 1222 changes the spatial quantization value at the time of compression in accordance with the resolution of each of the plurality of pieces of divided point cloud data of the same scene. As another example, the spatial quantization value determination unit 1222 changes the spatial quantization value at the time of compression in accordance with the density of the point cloud data in the predetermined space of each of the plurality of pieces of divided point cloud data of a same scene. As another example, the spatial quantization value determination unit 1222 changes the spatial quantization value at the time of compression in accordance with the resolution of each of the plurality of pieces of divided point cloud data of the same scene and the density of the point cloud data in the predetermined space.

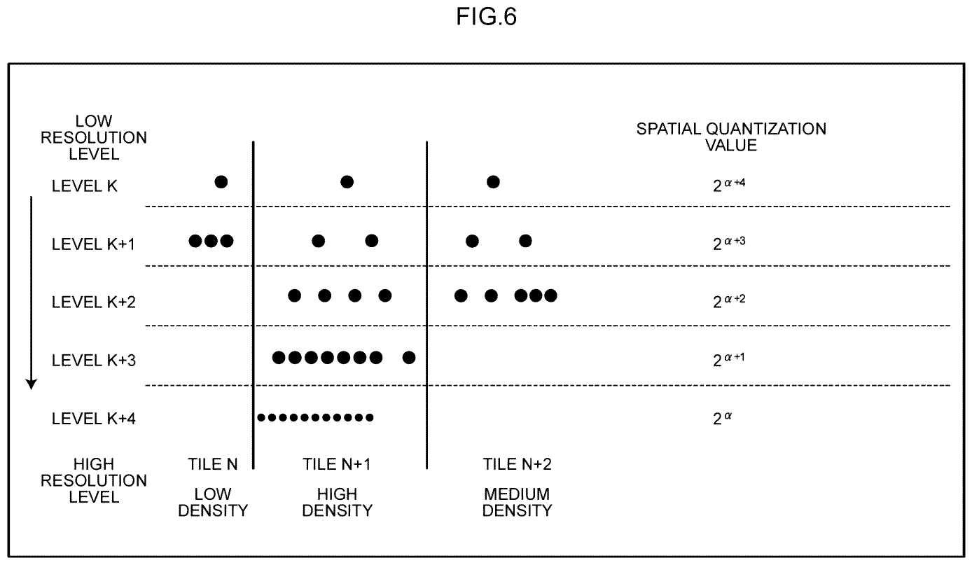

Hereinafter, an example of determination of the spatial quantization value by the spatial quantization value determination unit 1222 will be described with reference to FIGS. 6 to 9. FIGS. 6 to 9 are diagrams for illustrating the encoding apparatus according to the first embodiment.

In the example illustrated in FIG. 6, the spatial quantization value determination unit 1222 determines the spatial quantization value such that the higher the resolution of the point cloud data, the smaller the spatial quantization value will be. For example, the spatial quantization value determination unit 1222 determines the spatial quantization value such that the higher the resolution level, the smaller the spatial quantization value will be, for example, by determining the spatial quantization value to be ½ times every time the resolution level of the point cloud data increases (becomes higher in definition) by 1. Furthermore, the spatial quantization value determination unit 1222 determines the spatial quantization value as a power of a predetermined value. Specifically, the spatial quantization value determination unit 1222 determines the spatial quantization value to a power of 2.

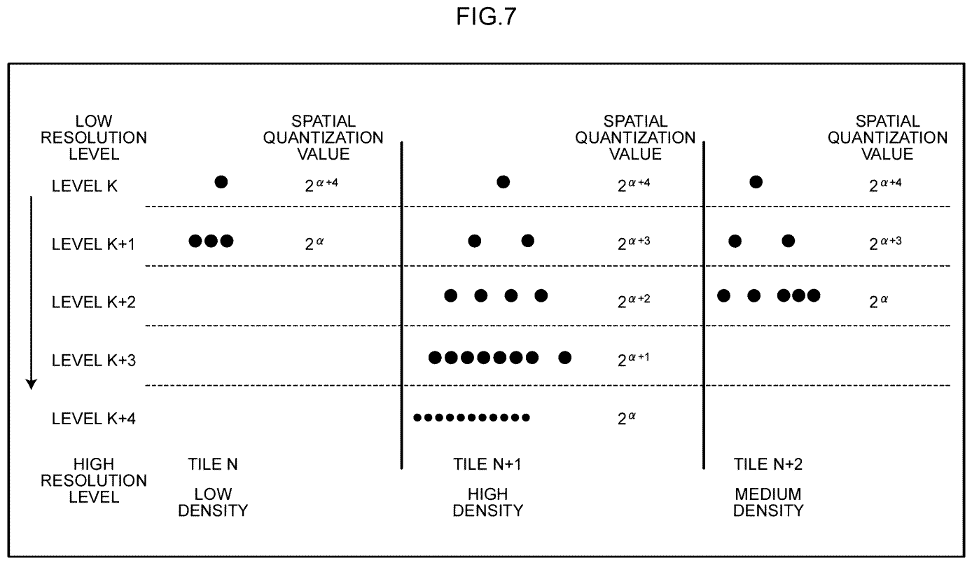

In the example illustrated in FIG. 7, the spatial quantization value determination unit 1222 determines the spatial quantization value such that the higher the density of the point cloud data, the smaller the spatial quantization value will be. Among the tiles N to N+2 at the same resolution level K+1, the spatial quantization value determination unit 1222 determines the spatial quantization value of the tile N highest in the point cloud data density to be 2^{α}, which is smaller than 2^{α+3} being the spatial quantization value of the tile N+1 and the tile N+2. Among the tiles N+1 and N+2 at the same resolution level K+2, the spatial quantization value determination unit 1222 determines the spatial quantization value of the tile N+2 higher in the point cloud data density to be 2^{α}, which is smaller than 2^{α+2} being the spatial quantization value of the tile N+1.

The spatial quantization value determination unit 1222 may determine the spatial quantization value of the divided point cloud data having the highest resolution in each of the plurality of divided spaces divided by the dividing unit 121 to be the same value. That is, the spatial quantization value determination unit 1222 may prioritize the spatial quantization value of the divided point cloud data at the highest definition level in each of the tile N, the tile N+1, and the tile N+2.

For example, the spatial quantization value determination unit 1222 determines the spatial quantization value of the divided point cloud data of the level K+1 having the highest resolution in the tile N, the divided point cloud data of the level K+4 having the highest resolution in the tile N+1, and the divided point cloud data of the level K+2 having the highest resolution in the tile N+2 to be the same value 2^{α}.

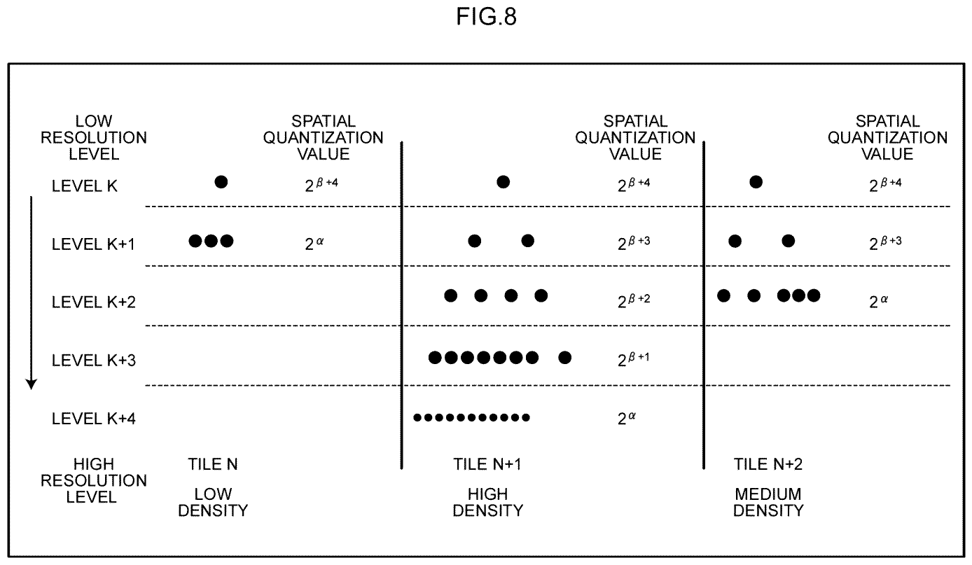

Furthermore, as illustrated in FIG. 8, also in a case where β>α, the spatial quantization value determination unit 1222 may prioritize the spatial quantization value of the divided point cloud data at the highest definition level in each of the plurality of tiles. In the example illustrated in FIG. 8, in comparison with the spatial quantization value of the divided point cloud data at the highest definition level in the same tile, the spatial quantization value of the other divided point cloud data is significantly larger. Even in such a case, the spatial quantization value determination unit 1222 determines the spatial quantization value of the divided point cloud data at the highest definition level to the same value 2^{α} in each tile, making it possible to improve the encoding efficiency while improving the image quality of the point cloud data at the high resolution level and maintaining the subjective image quality.

Furthermore, among the plurality of pieces of divided point cloud data divided for each resolution level by the dividing unit 121, the spatial quantization value determination unit 1222 may determine the spatial quantization value of the divided point cloud data having the highest density at each resolution level to be the same value. That is, the spatial quantization value determination unit 1222 may prioritize the spatial quantization value of the divided point cloud data having the highest density at each resolution.

For example, the spatial quantization value determination unit 1222 determines the spatial quantization value of the divided point cloud data of the tile N having the highest density at the level K+1, the divided point cloud data of the tile N+2 having the highest density at the level K+2, and the divided point cloud data of the tile N+1 having the highest density at the level K+4 to be the same value 2^{α}.

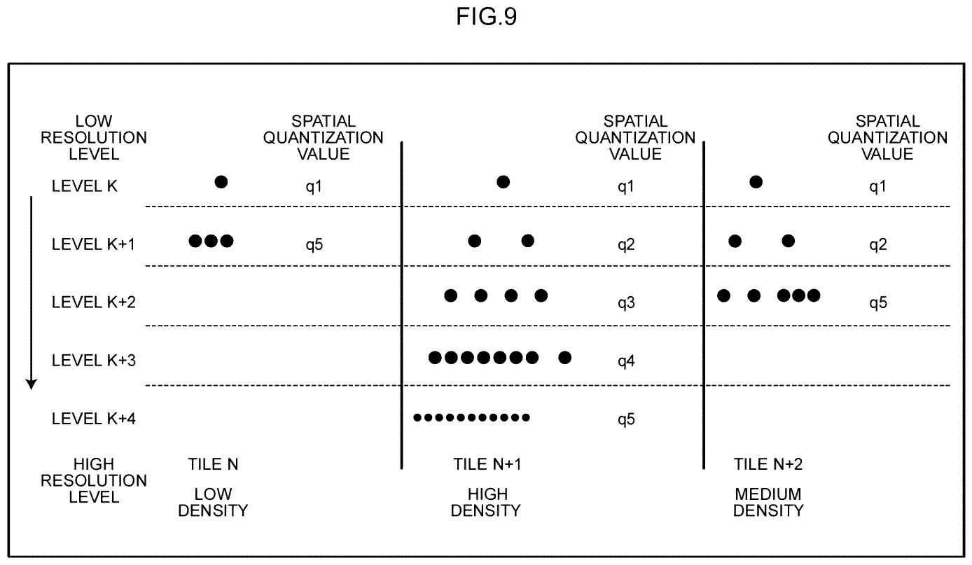

Furthermore, in the above-described example, the spatial quantization value determination unit 1222 determines the spatial quantization value to the power of 2, but the spatial quantization value may be set to a value other than the power of 2, such as a generic value. For example, the spatial quantization value determination unit 1222 determines the spatial quantization value of each of the plurality of pieces of divided point cloud data to be any of q1 to q5 that satisfies the relational expression of q5≤q4≤q3≤q2≤q1. In the example illustrated in FIG. 9, the spatial quantization value determination unit 1222 determines the spatial quantization value of each of the plurality of pieces of divided point cloud data to be any of q1 to q5 such that the higher the resolution of the point cloud data, the smaller the spatial quantization value will be, and the higher the density of the point cloud data, the smaller the spatial quantization value will be. Even in such a case, the spatial quantization value determination unit 1222 can determine the spatial quantization value of each of the plurality of pieces of point cloud data in accordance with the resolution and density of each of the plurality of pieces of point cloud data.

Returning to the description of FIG. 5. In the example illustrated in FIG. 5, based on a request from the reproduction apparatus 20, the reproduction target determination unit 1223 determines a reproduction target to be reproduced by the reproduction apparatus 20 among the plurality of pieces of point cloud data encoded by the encoding unit 123. For example, in response to a request from the reproduction apparatus 20, the reproduction target determination unit 1223 determines a reproduction target to be reproduced in a predetermined resolution, a predetermined region, a predetermined viewpoint, and a predetermined visual field, as a reproduction target to be transmitted (via communication) to the reproduction apparatus 20, from among a plurality of pieces of point cloud data encoded in advance with a plurality of spatial quantization values for each resolution.

As an example, in a case where the low quality point cloud data is requested as the reproduction target from the reproduction apparatus 20, the reproduction target determination unit 1223 determines low quality point cloud data encoded with the spatial quantization value of q1 being the highest value among q1, q1′ and q1″ to be the reproduction target by a low-level encoding unit (described below) in the encoding unit 123 (described below). The reproduction target determination unit 1223 determines low quality point cloud data encoded with the spatial quantization value of q2 being the highest value among q2, q2′, and q2″ to be the reproduction target by a medium-level (normal level) encoding unit (described below) in the encoding unit 123. The reproduction target determination unit 1223 determines low quality point cloud data encoded with the spatial quantization value of q3 being the highest value among q3, q3′, and q3″ to be a reproduction target by a high-level encoding unit (described below) in the encoding unit 123. In this manner, in a case where the low quality point cloud data is requested from the reproduction apparatus 20, the reproduction target determination unit 1223 determines the low quality point cloud data encoded with the spatial quantization values of q1, q2, and q3 to be the reproduction target.

The encoding unit 123 encodes each of the plurality of pieces of point cloud data based on the spatial quantization value determined by the determination unit 122. For example, the encoding unit 123 encodes each of the plurality of pieces of divided point cloud data at a precision corresponding to the spatial quantization value of each of the plurality of pieces of point cloud data. In the example illustrated in FIG. 1, the encoding unit 123 encodes each of the plurality of pieces of divided point cloud data based on the spatial quantization value of each of the plurality of pieces of divided point cloud data determined by the determination unit 122. For example, the encoding unit 123 encodes each of the plurality of pieces of divided point cloud data at precision corresponding to the spatial quantization value of each of the plurality of pieces of divided point cloud data.

The encoding unit 123 includes a plurality of encoding units each corresponding to the resolution level of each of the plurality of pieces of point cloud data. For example, the encoding unit 123 includes a plurality of encoding units each corresponding to the resolution level of each of the plurality of pieces of divided point cloud data divided by the dividing unit 121. The following will describe an example in which the encoding unit 123 includes a plurality of encoding units. However, the number of the plurality of encoding units included in the encoding unit 123 is not particularly limited, and may be any number corresponding to the number of resolution levels, for example.

As an example, the encoding unit 123 includes a low-level encoding unit, a medium-level encoding unit, and a high-level encoding unit when the resolution levels of the plurality of pieces of divided point cloud data are three resolution levels of a low level, a medium level, and a high level. Each of the low-level encoding unit, the medium-level encoding unit, and the high-level encoding unit receives input of level information related to a resolution level and a plurality of pieces of divided point cloud data corresponding to each piece of level information. The low-level encoding unit encodes (compresses) low-level divided point cloud data, the medium-level encoding unit encodes medium-level divided point cloud data, and the high-level encoding unit encodes high-level divided point cloud data.

In this case, for example, the low-level encoding unit encodes each of the plurality of low-level point cloud data with precision corresponding to any of the spatial quantization values of q1, q1′, and q″. When there is a relationship of q1>q1′>q1″, data encoded with the spatial quantization value of q1 is to be low quality point cloud data, data encoded with the spatial quantization value of q1′ is to be medium quality (normal quality) point cloud data, and data encoded with the spatial quantization value of q1″ is to be high quality point cloud data. The medium-level encoding and the high-level encoding unit also encode a plurality of pieces of point cloud data similarly to the low-level encoding unit. The encoding unit 123 may encode each of the plurality of pieces of point cloud data such that the data amount of the encoded point cloud data will be larger in the order of the high quality point cloud data, the normal quality point cloud data, and the low quality point cloud data.

As another example, when the resolution levels of the plurality of pieces of divided point cloud data are five resolution levels of levels K to K+4, the encoding unit 123 includes a level K encoding unit, a level K+1 encoding unit, a level K+2 encoding unit, a level K+3 encoding unit, and a level K+4 encoding unit. Each of the level K encoding unit to the level K+4 encoding unit receives input of level information related to a resolution level and a plurality of pieces of divided point cloud data corresponding to each piece of level information. Each of the level K encoding unit to the level K+4 encoding unit encodes (compresses) divided point cloud data at a level corresponding to each of the level K encoding unit to the level K+4 encoding unit among the divided point cloud data at the levels K to K+4.

The communication unit 14 communicates with a communication unit 21 of the reproduction apparatus 20. For example, the communication unit 14 transmits the reproduction target determined by the reproduction target determination unit 1223 to the communication unit 21 of the reproduction apparatus 20 via a telecommunication link such as a local area network (LAN) or the Internet. Examples of the communication unit 14 include a Network Interface Card (NIC).

Next, referring back to FIG. 1, the configuration of the reproduction apparatus 20 will be described. In the example illustrated in FIG. 1, the reproduction apparatus 20 includes a communication unit 21, a control unit 22, and a storage unit 23.

The communication unit 21 communicates with the communication unit 14 of the encoding apparatus 10. For example, the communication unit 21 receives the reproduction target determined by the reproduction target determination unit 1223 from the communication unit 14 of the encoding apparatus 10 via a telecommunication link such as a LAN or the Internet. Examples of the communication unit 21 include an NIC and the like.

The storage unit 23 stores a reproduction target, communication information, region information, viewpoint information, an OS, various programs, and the like. Examples of the storage unit 23 include a storage apparatus such as an HDD, an SSD, and an optical disk, and semiconductor memory capable of rewriting data such as RAM, flash memory, and NVSRAM.

The control unit 22 performs overall control of the reproduction apparatus 20. For example, the control unit 22 includes one or more processors having internal memory storing a program defining each processing procedure and storing control data, and the processor executes each processing using the program and the internal memory. Examples of the control unit 22 include electronic circuits such as a CPU, an MPU, and a GPU, and integrated circuits such as an ASIC and an FPGA. In the example illustrated in FIG. 1, the control unit 22 includes an acquisition unit 221, a request unit 222, and a reproduction unit 223.

The acquisition unit 221 acquires at least one of: communication information related to communication between the encoding apparatus 10 and the reproduction apparatus 20; region information related to a region in which a reproduction target requested by the reproduction apparatus 20 is reproduced; and viewpoint information related to a viewpoint in which the reproduction target is reproduced by the reproduction apparatus 20. In the example illustrated in FIG. 1, the acquisition unit 221 acquires communication information, region information, and viewpoint information, and a reproduction target received by the communication unit 21. A method of acquiring the communication information, the region information, and the viewpoint information by the acquisition unit 221 is not particularly limited. For example, the acquisition unit 221 may acquire the communication information, the region information, and the viewpoint information via the communication unit 21 and the communication unit 14 of the encoding apparatus 10, or may acquire the information from the outside of the encoding system 1.

The request unit 222 requests a reproduction target to be reproduced by the reproduction apparatus 20 among the plurality of pieces of point cloud data encoded by the encoding unit 123. The request unit 222 may request the reproduction target based on the information acquired by the acquisition unit 221 among the communication information, the region information, and the viewpoint information.

As an example, in a case where a width of a communication band indicated by the communication information acquired by the acquisition unit 221 is a threshold or more, the request unit 222 requests a reproduction target having a smaller spatial quantization value than that in a case where the width of the communication band is not the threshold or more. As another example, in a case where the region indicated by the region information acquired by the acquisition unit 221 is within a range of a Region of Interest (ROI), the request unit 222 requests the reproduction target having a smaller spatial quantization value than that in a case where the region is not within the range of the Region of Interest. As another example, in a case where the distance between the viewpoint indicated by the viewpoint information acquired by the acquisition unit 221 and the reproduction target is within a predetermined range, the request unit 222 requests the reproduction target having a smaller spatial quantization value than that in a case where the distance is not within the predetermined range. For example, in a case where the reproduction target reproduced by the reproduction apparatus 20 is viewed from a close viewpoint, the request unit 222 requests high quality point cloud data having a smaller spatial quantization value such as high-density point cloud data than in a case where the reproduction target is viewed from a far viewpoint.

In a case where the high quality point cloud data is requested as the reproduction target, the request unit 222 may determine the point cloud data up to the medium level resolution as the reproduction target instead of the point cloud data up to the high level resolution. Note that, in this case, the request unit 222 determines the point cloud data with the medium level resolution satisfying a predetermined spatial resolution, as the reproduction target.

The reproduction unit 223 reproduces the reproduction target. For example, the reproduction unit 223 decodes the reproduction target acquired by the acquisition unit 221 and displays the decoded reproduction target on the display unit to reproduce the reproduction target. As illustrated in FIG. 1, when the reproduction apparatus 20 has no display unit, the reproduction unit 223 displays the decoded reproduction target on a display unit outside the reproduction apparatus 20, but when the reproduction apparatus 20 includes the display unit, the reproduction unit 223 may display the decoded reproduction target on the display unit in the reproduction apparatus 20.

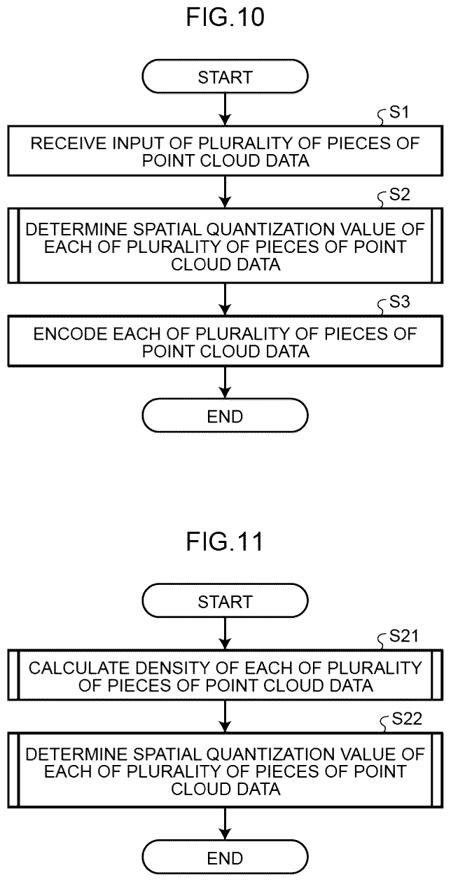

Next, an example of each processing executed by the encoding apparatus 10 according to the first embodiment will be described with reference to FIGS. 10 to 14. FIGS. 10 to 14 are flowcharts illustrating an example of processing of the encoding apparatus according to the first embodiment. First, an example of overall processing executed by the encoding apparatus 10 will be described with reference to FIG. 10.

In step S1, the input receiving unit 11 receives an input of a plurality of pieces of point cloud data.

In step S2, the spatial quantization value determination unit 1222 determines the spatial quantization value of each of the plurality of pieces of point cloud data based on at least one of the resolution and the density of each of the plurality of pieces of point cloud data an input of which has been received by the input receiving unit 11.

In step S3, the encoding unit 123 encodes each of the plurality of pieces of point cloud data based on the spatial quantization value determined by the spatial quantization value determination unit 1222.

Next, an example of the spatial quantization value determination processing corresponding to step S2 in FIG. 10 will be described in detail with reference to FIG. 11.

In step S21, the density calculation unit 1221 calculates the density of each of the plurality of pieces of point cloud data.

In step S22, the spatial quantization value determination unit 1222 determines the spatial quantization value of each of the plurality of pieces of point cloud data.

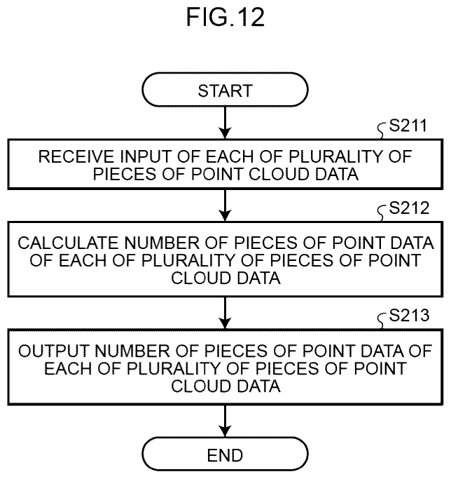

Next, an example of density calculation processing corresponding to step S21 of FIG. 11 will be described in detail with reference to FIG. 12.

In step S211, the density calculation unit 1221 receives an input of each of the plurality of pieces of point cloud data from the input receiving unit 11.

In step S212, the density calculation unit 1221 calculates the number of pieces of point data of each of the plurality of pieces of point cloud data an input of which has been received.

In step S213, the density calculation unit 1221 outputs the calculated number of pieces of point data of each of the plurality of pieces of point cloud data. For example, the density calculation unit 1221 outputs information related to the calculated number of pieces of point data of each of the plurality of pieces of point cloud data to the spatial quantization value determination unit 1222 as density calculation processing result information related to the result of the density calculation processing.

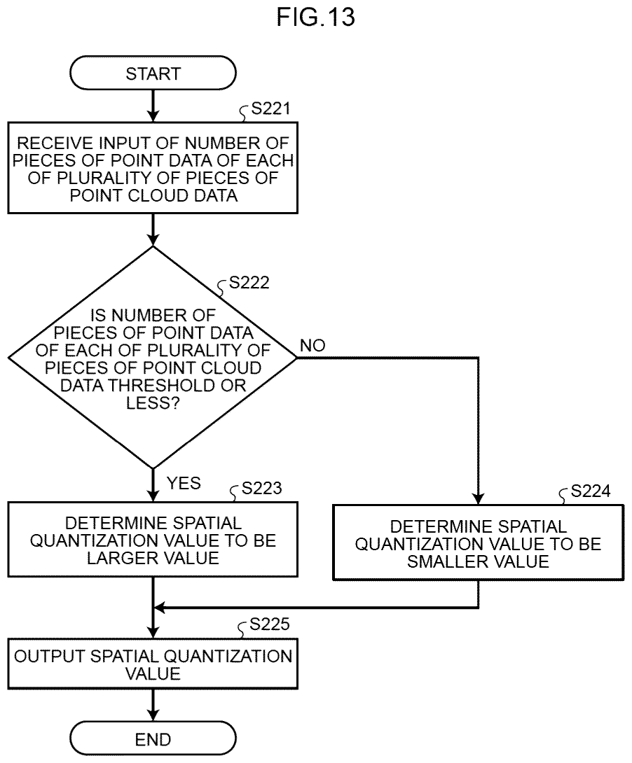

Next, an example of the spatial quantization value determination processing corresponding to step S22 of FIG. 11 will be described in detail with reference to FIG. 13.

In step S221, the spatial quantization value determination unit 1222 receives an input of the number of pieces of point data of each of the plurality of pieces of point cloud data from the density calculation unit 1221. For example, the spatial quantization value determination unit 1222 receives an input of the number of pieces of point data of each of the plurality of pieces of point cloud data indicated by the density calculation processing result information output from the density calculation unit 1221.

In step S222, the spatial quantization value determination unit 1222 judges whether the number of pieces of point data of each of the plurality of pieces of point cloud data is a threshold or less. That is, the spatial quantization value determination unit 1222 judges whether the number of pieces of point data is a threshold or less for each piece of point cloud data included in the plurality of pieces of point cloud data.

In a case where the number of pieces of point data of the point cloud data included in the plurality of pieces of point cloud data is judged to be the threshold or less (Yes in step S222), the spatial quantization value determination unit 1222 determines, in step S223, the spatial quantization value of the point cloud data the number of pieces of point data of which is the threshold or less to be a value larger than the spatial quantization value of the point cloud data the number of pieces of point data of which is not the threshold or less. For example, the spatial quantization value determination unit 1222 determines the spatial quantization value of the point cloud data the number of pieces of point data of which is the threshold or less to be the spatial quantization value for the sparse data being the low-density point cloud data larger than the spatial quantization value of the point cloud data the number of pieces of point data of which is greater than the threshold.

In a case where the number of pieces of point data of the point cloud data included in the plurality of pieces of point cloud data is judged not to be the threshold or less (No in step S222), the spatial quantization value determination unit 1222 determines, in step S224, the spatial quantization value of the point cloud data the number of pieces of point data of which is not the threshold or less to be a value smaller than the spatial quantization value of the point cloud data the number of pieces of point data of which is the threshold or less. For example, the spatial quantization value determination unit 1222 determines the spatial quantization value of the point cloud data the number of pieces of point data of which is greater than the threshold to be the spatial quantization value for the dense data being the high-density point cloud data smaller than the spatial quantization value of the point cloud data the number of pieces of point data of which is the threshold or less.

In step S225, the spatial quantization value determination unit 1222 outputs the determined spatial quantization value.

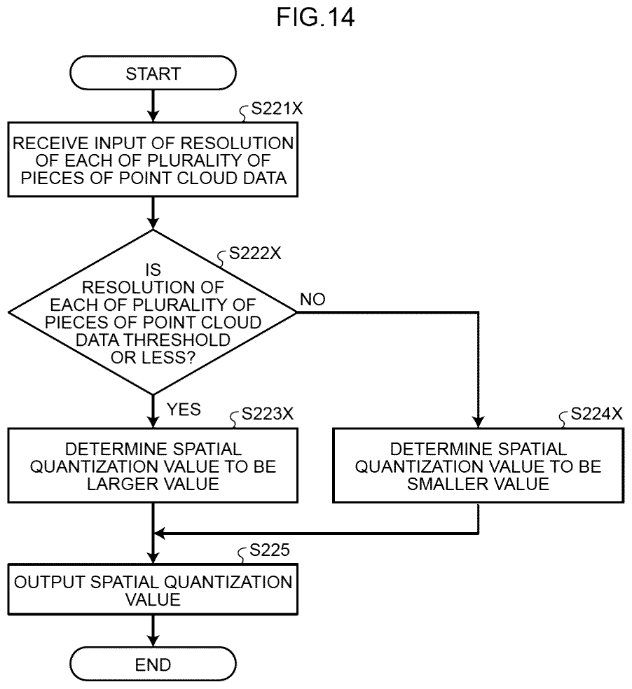

Next, another example of the spatial quantization value determination processing corresponding to step S22 of FIG. 11 will be described in detail with reference to FIG. 14. Step S225 in FIG. 14 is similar to step S225 in FIG. 13, and thus description thereof is omitted.

In step S221X, the spatial quantization value determination unit 1222 receives an input of the resolution of each of the plurality of pieces of point cloud data. As an example, the spatial quantization value determination unit 1222 receives an input of level information related to the resolution level of each of the plurality of pieces of point cloud data from the input receiving unit 11. As another example, the spatial quantization value determination unit 1222 receives an input of level information related to the resolution level of each of the plurality of pieces of divided point cloud data from the dividing unit 121.

In step S222X, the spatial quantization value determination unit 1222 judges whether the resolution of each of the plurality of pieces of point cloud data is a threshold or less. That is, the spatial quantization value determination unit 1222 judges whether the resolution is a threshold or less for each piece of point cloud data included in the plurality of pieces of point cloud data.

In a case where the resolution of the point cloud data included in the plurality of pieces of point cloud data is judged to be the threshold or less (Yes in step S222X), the spatial quantization value determination unit 1222 determines, in step S223X, the spatial quantization value of the point cloud data the resolution of which is the threshold or less to be a value larger than the spatial quantization value of the point cloud data the resolution of which is not the threshold or less. For example, the spatial quantization value determination unit 1222 determines the spatial quantization value of the point cloud data the resolution of which is the threshold or less to be the spatial quantization value for sparse data larger than the spatial quantization value of the point cloud data the resolution of which is greater than the threshold.

In a case where the resolution of the point cloud data included in the plurality of pieces of point cloud data is judged not to be the threshold or less (No in step S222X), the spatial quantization value determination unit 1222 determines, in step S224X, the spatial quantization value of the point cloud data of which the resolution is not the threshold or less to be a value smaller than the spatial quantization value of the point cloud data the resolution of which is the threshold or less. For example, the spatial quantization value determination unit 1222 determines the spatial quantization value of the point cloud data the resolution of which is greater than the threshold to be the spatial quantization value for the dense data smaller than the spatial quantization value of the point cloud data the resolution of which is the threshold or less.

In the examples illustrated in FIGS. 13 and 14, the spatial quantization value determination unit 1222 determines the spatial quantization value based on one of the density and the resolution of the point cloud data, but may determine the spatial quantization value based on both of these. For example, when both the number of points and the resolution of the point cloud data are greater than the threshold, the spatial quantization value determination unit 1222 may determine the spatial quantization value of the point cloud data as a spatial quantization value for the high quality point cloud data (for superdense data). For example, when one of the number of points and the resolution of the point cloud data is greater than the threshold, the spatial quantization value determination unit 1222 may determine the spatial quantization value of the point cloud data as a spatial quantization value for the normal quality point cloud data (for dense data). For example, when both the number of points and the resolution of the point cloud data are the threshold or less, the spatial quantization value determination unit 1222 may determine the spatial quantization value of the point cloud data as a spatial quantization value for the low quality point cloud data (for sparse data).

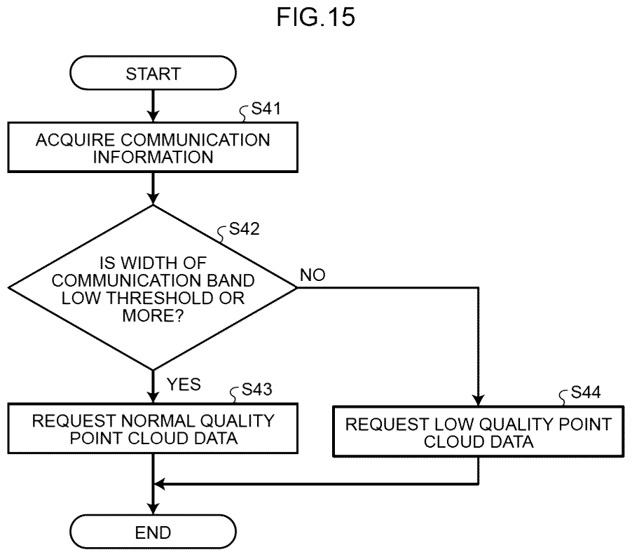

Next, an example of each processing executed by the reproduction apparatus 20 according to the first embodiment will be described with reference to FIGS. 15 to 19. FIGS. 15 to 19 are flowcharts illustrating an example of processing of the reproduction apparatus according to the first embodiment. First, an example of request processing executed by the reproduction apparatus 20 will be described with reference to FIG. 15.

In step S41, the acquisition unit 221 acquires communication information. In the example illustrated in FIG. 15, the acquisition unit 221 acquires communication information including communication band information such as a communicable band of a network link enabling communication between the encoding apparatus 10 and the reproduction apparatus 20.

In step S42, the request unit 222 judges whether the width of the communication band indicated by the communication information acquired by the acquisition unit 221 is a low threshold or more.

In a case where the width of the communication band is judged to be the low threshold or more (Yes in step S42), in step S43, the request unit 222 requests normal quality point cloud data having a smaller spatial quantization value than that in a case where the width of the communication band is judged not to be the low threshold or more, as the reproduction target.

In a case where the width of the communication band is judged not to be the low threshold or more (No in step S42), in step S44, the request unit 222 requests low quality point cloud data having a larger spatial quantization value than that in a case where the width of the communication band is judged to be the low threshold or more, as the reproduction target.

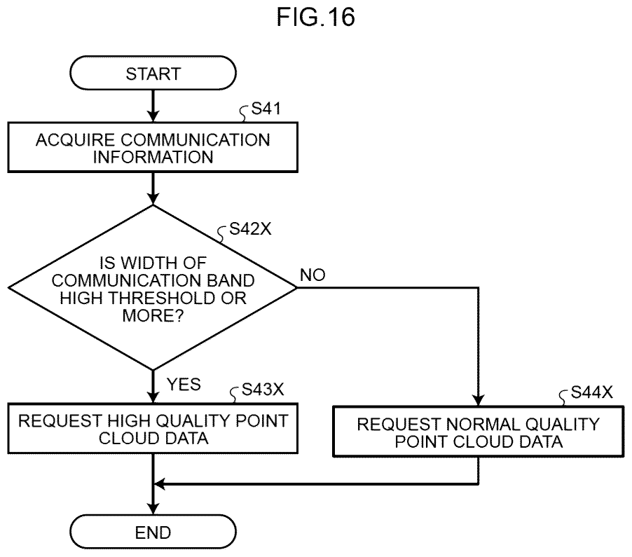

Next, another example of request processing executed by the reproduction apparatus 20 will be described with reference to FIG. 16. Step S41 in FIG. 16 is similar to step S41 in FIG. 15.

In step S42X, the request unit 222 judges whether the width of the communication band indicated by the communication information acquired by the acquisition unit 221 is a high threshold or more.

In a case where the width of the communication band is judged to be the high threshold or more (Yes in step S42X), the request unit 222 requests, in step S43X, high quality point cloud data having a smaller spatial quantization value than that in a case where the width of the communication band is judged not to be the high threshold or more, as the reproduction target. In this manner, in a case where the width of the communication band is the high threshold or more indicating that there is a sufficient width of a communication band, the request unit 222 requests the high quality point cloud data as the reproduction target in order to improve the quality of the reproduction target.

In a case where the width of the communication band is judged not to be the high threshold or more (No in step S42X), the request unit 222 requests, in step S44X, normal quality point cloud data having a larger spatial quantization value than that in a case where the width of the communication band is judged to be the high threshold or more, as the reproduction target.

While the request unit 222 in the examples illustrated in FIGS. 15 and 16 separately performs the request processing illustrated in FIG. 15 and the request processing illustrated in FIG. 16, these procedures of the request processing may be performed together. For example, in the case of Yes in step S42, the request unit 222 may perform the processing of steps S42X to S44X instead of step S43. In this manner, the request unit 222 can request an appropriate reproduction target more suitable to the communication band by performing two-stage judgment.

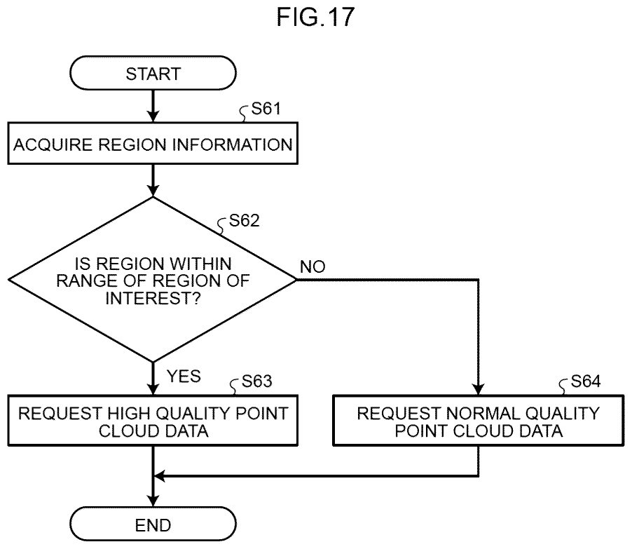

Next, another example of request processing executed by the reproduction apparatus 20 will be described with reference to FIG. 17.

In step S61, the acquisition unit 221 acquires region information.

In step S62, the request unit 222 judges whether the region indicated by the region information acquired by the acquisition unit 221 is within a range of a Region of Interest. For example, with reference to the Region of Interest indicated by Region of Interest information acquired in advance by the acquisition unit 221, the request unit 222 judges whether a region to be requested by the request unit 222, which is indicated by region information, falls within the range of the Region of Interest

In a case where the region is judged to be within the range of the Region of Interest (Yes in step S62) the request unit 222 requests, in step S63, high quality point cloud data having a smaller spatial quantization value than that in a case where this region is judged not to be within the range of the Region of Interest, as the reproduction target.

When the region is judged not to be within the range of the Region of Interest (No in step S62) the request unit 222 requests, in step S64, normal quality point cloud data having a larger spatial quantization value than that in a case where this region is judged to be within the range of the Region of Interest, as the reproduction target.

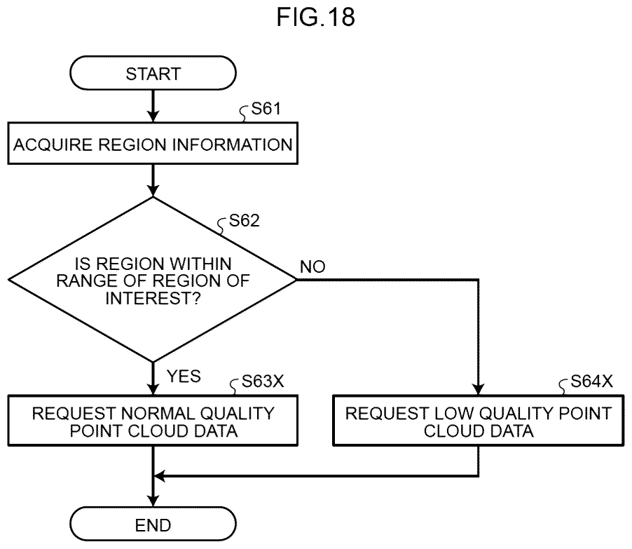

Next, another example of request processing executed by the reproduction apparatus 20 will be described with reference to FIG. 18. Steps S61 and S62 in FIG. 18 are similar to steps S61 and S62 in FIG. 17.

In a case where the region is judged to be within the range of the Region of Interest (Yes in step S62) the request unit 222 requests, in step S63X, normal quality point cloud data having a smaller spatial quantization value than that in a case where this region is judged not to be within the range of the Region of Interest, as the reproduction target.

In a case where the region is judged not to be within the range of the Region of Interest (No in step S62) the request unit 222 requests, in step S64X, low quality point cloud data having a larger spatial quantization value than that in a case where this region is judged to be within the range of the Region of Interest, as the reproduction target.

As illustrated in FIGS. 17 and 18, the reproduction target to be requested by the request unit 222 in a case where the region is judged to be within the range of the Region of Interest is not particularly limited as long as the spatial quantization value is smaller than that in a case where this region is judged not to be within the range of the Region of Interest. For example, the reproduction target may be high quality point cloud data or normal quality point cloud data.

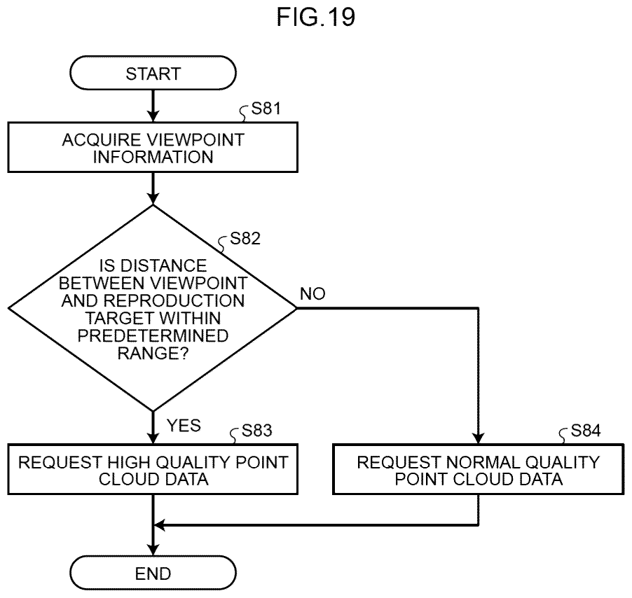

Next, another example of request processing executed by the reproduction apparatus 20 will be described with reference to FIG. 19.

In step S81, the acquisition unit 221 acquires viewpoint information.

In step S82, the request unit 222 judges whether the distance between the viewpoint indicated by the viewpoint information acquired by the acquisition unit 221 and the reproduction target is within a predetermined range.

In a case where the distance between the viewpoint and the reproduction target is judged to be within the predetermined range (Yes in step S82), the request unit 222 requests, in step S83, high quality point cloud data having a smaller spatial quantization value than that in a case where the distance is judged not to be within the predetermined range, as the reproduction target.

In a case where the distance between the viewpoint and the reproduction target is judged not to be within the predetermined range (No in step S82), the request unit 222 requests, in step S84, normal quality point cloud data having a larger spatial quantization value than that in a case where the distance is judged to be within the predetermined range, as the reproduction target.

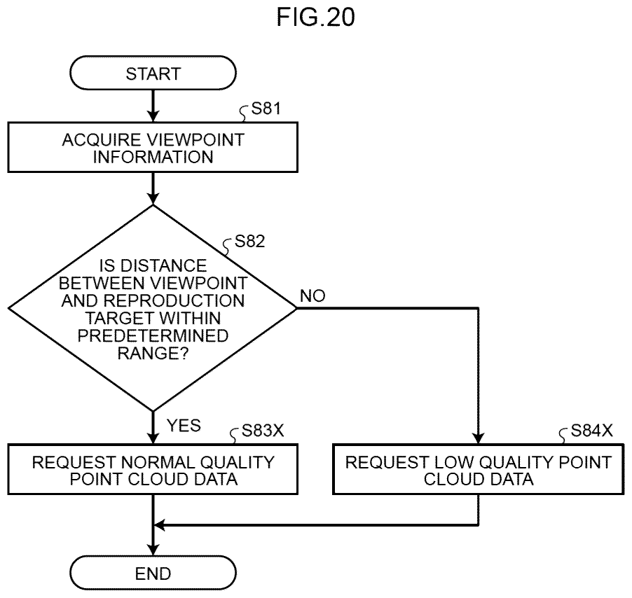

Next, another example of request processing executed by the reproduction apparatus 20 will be described with reference to FIG. 20. Steps S81 and S82 in FIG. 20 are similar to steps 881 and S82 in FIG. 19.

In a case where the distance between the viewpoint and the reproduction target is judged to be within the predetermined range (Yes in step S82), the request unit 222 requests, in step S83X, normal quality point cloud data having a smaller spatial quantization value than that in a case where the distance is judged not to be within the predetermined range, as the reproduction target.

In a case where the distance between the viewpoint and the reproduction target is judged not to be within the predetermined range (No in step S82), the request unit 222 requests, in step S84X, low quality point cloud data having a larger spatial quantization value than that in a case where the distance is judged to be within the predetermined range, as the reproduction target.

As illustrated in FIGS. 19 and 20, the reproduction target to be requested by the request unit 222 in a case where the distance between the viewpoint and the reproduction target is judged to be within the predetermined range is not particularly limited as long as the spatial quantization value is smaller than that in a case where the distance is judged not to be within the predetermined range. For example, the reproduction target may be high quality point cloud data or normal quality point cloud data.

### 2. SECOND EMBODIMENT

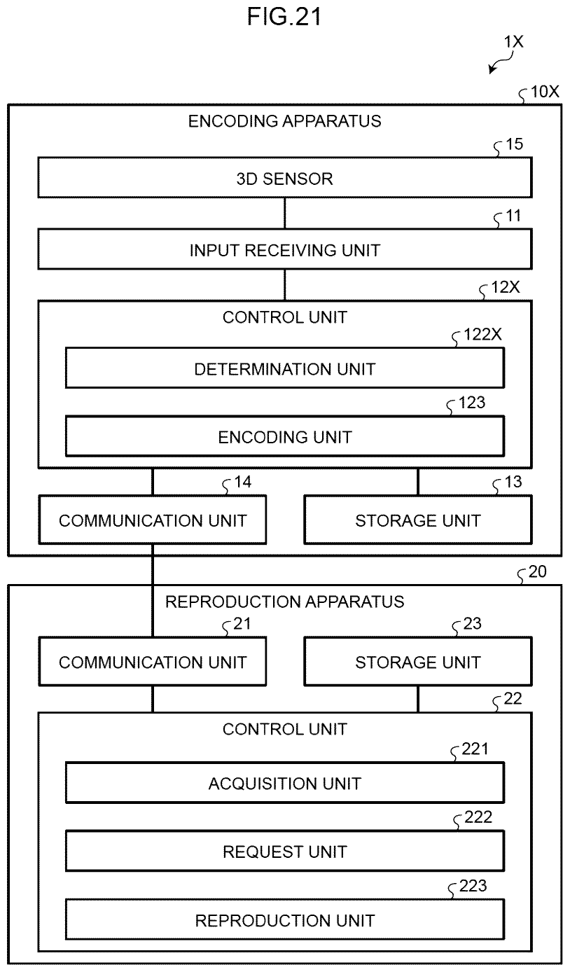

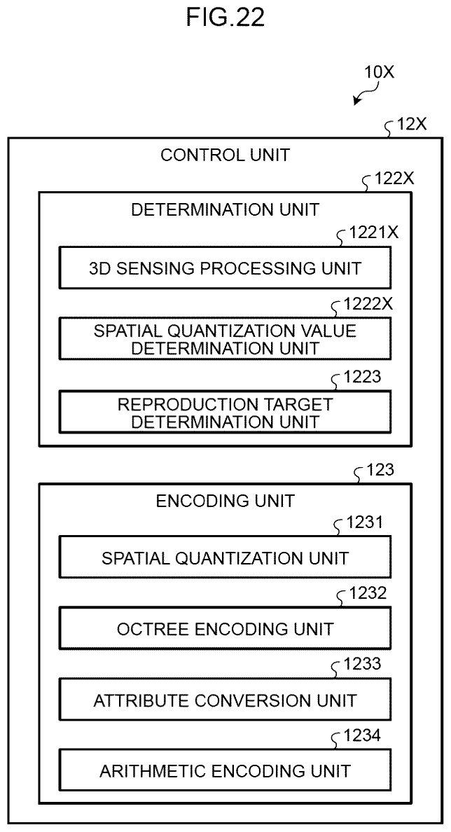

The encoding system according to one aspect of the present disclosure may further include a 3D sensing processing unit instead of or in addition to the dividing unit described above. An encoding system 1X according to a second embodiment will be described below with reference to FIGS. 21 and 22. FIG. 21 is a diagram illustrating an example of a schematic configuration of the encoding system according to the second embodiment. FIG. 22 is a diagram illustrating an example of a configuration of a control unit of an encoding apparatus according to the second embodiment.

In the example illustrated in FIG. 21, the encoding system 1X includes an encoding apparatus 10X instead of the encoding apparatus 10 according to the first embodiment. Except for this point, the encoding system 1X is similar to the encoding system 1 according to the first embodiment. The encoding apparatus 10X includes a control unit 12X instead of the control unit 12 in the first embodiment, and further includes a 3D sensor 15. Except for this point, the encoding apparatus 10X is similar to the encoding apparatus 10 according to the first embodiment.

The 3D sensor 15 generates a plurality of pieces of point cloud data including 3D point cloud data, and inputs the plurality of pieces of point cloud data generated to the input receiving unit 11. In the example illustrated in FIG. 21, the encoding apparatus 10X includes the 3D sensor 15, but may omit the 3D sensor 15.

The control unit 12X includes a determination unit 122X instead of the dividing unit 121 and the determination unit 122 in the first embodiment. Except for this point, the control unit 12X is similar to the control unit 12 in the first embodiment. Next, the configuration of the determination unit 122X will be described with reference to FIG. 22.

In the example illustrated in FIG. 22, the determination unit 122X includes a 3D sensing processing unit 1221X and a spatial quantization value determination unit 1222X instead of the density calculation unit 1221 and the spatial quantization value determination unit 1222. Except for this point, the determination unit 122X is similar to the determination unit 122 in the first embodiment.

The 3D sensing processing unit 1221X detects at least one of the resolution and the density of the 3D point cloud data based on 3D point cloud data an input of which has been received by the input receiving unit 11. The 3D sensing processing unit 1221X may detect the resolution of the 3D point cloud data based on the 3D point cloud data an input of which has been received by the input receiving unit 11, and may divide the 3D point cloud data into a plurality of pieces of divided point cloud data based on the detected resolution of the 3D point cloud data. In this case, the 3D sensing processing unit 1221X divides the 3D point cloud data into the plurality of pieces of divided point cloud data by classifying the detected resolution of the 3D point cloud data based on information related to at least one of: the area of the space at the time of encoding the point cloud data set by the control unit 12X that controls the 3D sensing processing unit 1221X; and the resolution, for example.

The spatial quantization value determination unit 1222X determines the spatial quantization value of each of the plurality of pieces of point cloud data based on at least one of the resolution and the density of the 3D point cloud data detected by the 3D sensing processing unit 1221X. The spatial quantization value determination unit 1222X may determine the spatial quantization value of each of the plurality of pieces of divided point cloud data divided by the 3D sensing processing unit 1221X based on at least one of the resolution and the density of the 3D point cloud data detected by the 3D sensing processing unit 1221X.

### 3. HARDWARE CONFIGURATION EXAMPLE

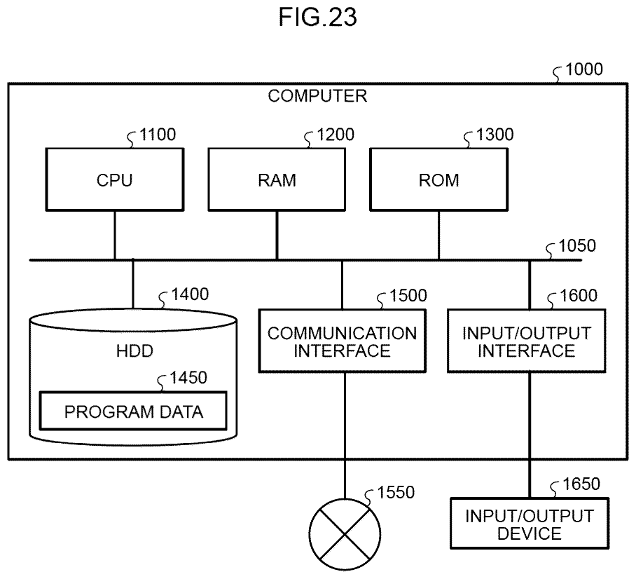

Various apparatuses such as the encoding apparatus 10, the encoding apparatus 10X, and the reproduction apparatus 20 described above can include a computer. An example will be described with reference to FIG. 23.

FIG. 23 is a diagram illustrating an example of a hardware configuration of the apparatus. A computer 1000 as an example includes a CPU 1100, RAM 1200, Read Only Memory (ROM) 1300, a HDD 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of Components. For example, the CPU 1100 loads a program stored in the ROM 1300 or the HDD 1400 onto the RAM 1200, and executes processing corresponding to various programs.

The ROM 1300 stores a boot program such as a Basic Input Output System (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records a program for executing individual operations according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a loudspeaker, or a printer via the input/output interface 1600. Furthermore, the input/output interface 1600 may function as a media interface for reading a program or the like recorded on predetermined recording medium (or media). The media include optical recording media such as a Digital Versatile Disc (DVD) or a Phase change rewritable Disk (PD), a magneto-optical recording medium such as a Magneto-Optical disk (MO), a tape medium, a magnetic recording medium, and semiconductor memory.

At least some of the functions of the encoding apparatus 10, the encoding apparatus 10X, the reproduction apparatus 20, and the like described above may be implemented, for example, by the CPU 1100 of the computer 1000 executing a program loaded on the RAM 1200. In addition, the HDD 1400 stores programs according to the present disclosure, and the like. While the CPU 1100 executes program data 1450 read from the HDD 1400, the CPU 1100 may acquire these programs from another device via the external network 1550, as another example.

### 4. EXEMPLARY EFFECTS

As described with reference to FIGS. 1 to 22 and the like, one of the disclosed techniques is the encoding apparatus 10 and the like. The encoding apparatus 10 includes: the input receiving unit 11 that receives an input of a plurality of pieces of point cloud data; the determination unit 122 (spatial quantization value determination unit 1122) that determines a spatial quantization value of each of the plurality of pieces of point cloud data based on at least one of a resolution and a density of each of the plurality of pieces of point cloud data an input of which has been received by the input receiving unit 11; and the encoding unit 123 that encodes each of the plurality of pieces of point cloud data based on the spatial quantization value determined by the determination unit 122.

The encoding apparatus 10 determines the spatial quantization value of each of the plurality of pieces of point cloud data based on at least one of the resolution and the density of each of the plurality of pieces of point cloud data, making it possible to reduce the data size of each of the plurality of pieces of point cloud data at the time of compression (at the time of encoding). This enables the encoding apparatus 10 to improve the encoding efficiency. For example, the encoding apparatus 10 can improve the encoding efficiency by about 10%. Furthermore, as compared with a case where the same spatial quantization value is simply determined for each resolution level, the encoding apparatus 10 can perform encoding that does not degrade subjective image quality while reducing the data size.

As described with reference to FIGS. 1 to 22 and the like, the input receiving unit 11 may receive an input of a plurality of pieces of point cloud data including 3D point cloud data. The encoding apparatus 10 can improve the encoding efficiency of 3D point cloud data in particular.

As described with reference to FIGS. 1 to 22 and the like, the determination unit 122 may determine the spatial quantization value such that the higher the resolution of the point cloud data, the smaller the spatial quantization value will be. This makes it possible for the encoding apparatus 10 to encode each of the plurality of pieces of point cloud data with an appropriate spatial quantization scale corresponding to each resolution level. As a result, the encoding apparatus 10 can improve the image quality of the point cloud data at the high resolution level, reduce the overall amount of encoding processing with no unnecessarily high precision encoding on the point cloud data at the low resolution level, making it possible to improve the encoding efficiency while maintaining the subjective image quality.

As described with reference to FIGS. 1 to 22 and the like, the determination unit 122 may determine the spatial quantization value such that the higher the density of the point cloud data, the smaller the spatial quantization value will be. There is a tendency that the higher the density of the point cloud data, the more the subjective deterioration in image quality will be noticeable and easily perceived. In relation to this, the encoding apparatus 10 can improve the image quality of the point cloud data having a higher density and make the subjective deterioration in image quality less noticeable.

As described with reference to FIGS. 1 to 22 and the like, the determination unit 122 may determine the spatial quantization value to a power of a predetermined value. This makes it possible for the encoding apparatus 10 to determine the spatial quantization value close to the octree spatial quantization value in the GPCC.

As described with reference to FIGS. 1 to 22 and the like, the determination unit 122 may determine the spatial quantization value to the power of 2. This makes it possible for the encoding apparatus 10 to determine the spatial quantization value closer to the octree spatial quantization value in the GPCC.

As described with reference to FIGS. 1 to 22 and the like, the determination unit 122 (reproduction target determination unit 1223) may determine the reproduction target to be reproduced by the reproduction apparatus 20 among the plurality of pieces of point cloud data encoded by the encoding unit 123 based on a request from the reproduction apparatus 20. This makes it possible for the encoding apparatus 10 to appropriately switch the quality and reproduction rate of the reproduction target in response to the request from the reproduction apparatus 20. This enables the encoding apparatus 10, for example, to improve the image quality in the reproduction target of the reproduction apparatus 20 in response to the request, or reduce the decrease in the rate of reproducing the reproduction target by the reproduction apparatus 20 due to an increase in the transmission amount of encoded point cloud data of low resolution. In this manner, the encoding apparatus 10 can improve convenience of reproduction of a reproduction target by the reproduction apparatus 20.

As described with reference to FIGS. 1 to 22 and the like, the encoding apparatus 10 may further include the dividing unit 121 that divides each of the plurality of pieces of point cloud data into the plurality of pieces of divided point cloud data based on at least one of the space including each of the plurality of pieces of point cloud data and the resolution of each of the plurality of pieces of point cloud data, the determination unit 122 may determine the spatial quantization value of each of the plurality of pieces of divided point cloud data based on at least one of the resolution and the density of each of the plurality of pieces of divided point cloud data divided by the dividing unit 121, and the encoding unit 123 may encode each of the plurality of pieces of divided point cloud data based on the spatial quantization value of each of the plurality of pieces of divided point cloud data determined by the determination unit 122. This makes it possible for the encoding apparatus 10 to determine an appropriate spatial quantization value for each of the plurality of pieces of divided point cloud data and encode each data.

As described with reference to FIGS. 1 to 22 and the like, the dividing unit 121 may divide the space including each of the plurality of pieces of point cloud data into the plurality of divided spaces to divide each of the plurality of pieces of point cloud data into the plurality of divided point cloud data, and the determination unit 122 may determine the spatial quantization value of the divided point cloud data having the highest resolution in each of the plurality of divided spaces divided by the dividing unit 121 to be the same value. This makes it possible for the encoding apparatus 10 to improve the image quality of the divided point cloud data having the highest resolution in each of the plurality of divided spaces. Furthermore, even in a case where the spatial quantization value of another piece of divided point cloud data in the same divided space is significantly larger than the spatial quantization value of the point cloud data having the highest resolution, the encoding apparatus 10 can improve the encoding efficiency while improving the image quality of the point cloud data at the high resolution level and maintaining the subjective image quality.

As described with reference to FIGS. 1 to 22 and the like, the dividing unit 121 may divide each of the plurality of pieces of point cloud data into the plurality of pieces of divided point cloud data for each resolution level of each of the plurality of pieces of point cloud data, and the determination unit 122 may determine the spatial quantization value of the divided point cloud data having the highest density at each resolution level among the plurality of pieces of point cloud data divided for each resolution level by the dividing unit 121, to be the same value. This makes it possible for the encoding apparatus 10 to improve the encoding efficiency while improving the image quality of the divided point cloud data having the highest density and maintaining the subjective image quality.

As described with reference to FIGS. 1 to 22 and the like, there may be further provided the 3D sensing processing unit 1221X that detects at least one of the resolution and the density of the 3D point cloud data based on 3D point cloud data an input of which has been received by the input receiving unit 11, and the determination unit 122 may determine the spatial quantization value of each of the plurality of pieces of point cloud data based on at least one of the resolution and the density of the 3D point cloud data detected by the 3D sensing processing unit 1221X. This makes it possible for the encoding apparatus 10 to improve the encoding efficiency of the 3D point cloud data. Furthermore, even with no density calculation unit 1221, the encoding apparatus 10 can calculate the density of each of the plurality of pieces of point cloud data by using the 3D sensing processing unit 1221X.

As described with reference to FIGS. 1 to 22 and the like, the 3D sensing processing unit 1221X may detect the resolution of the 3D point cloud data based on the 3D point cloud data an input of which has been received by the input receiving unit 11 and divide the 3D point cloud data into the plurality of pieces of divided point cloud data based on the detected resolution of the 3D point cloud data, the determination unit 122 may determine the spatial quantization value of each of the plurality of pieces of divided point cloud data divided by the 3D sensing processing unit 1221X based on at least one of the resolution and the density of the 3D point cloud data detected by the 3D sensing processing unit 1221X, and the encoding unit 123 may encode each of the plurality of pieces of divided point cloud data based on the spatial quantization value of each of the plurality of pieces of divided point cloud data determined by the determination unit 122. This makes it possible for the encoding apparatus 10 to determine an appropriate spatial quantization value for each of the plurality of pieces of divided point cloud data and encode each data, even without the dividing unit 121.

The encoding system described with reference to FIGS. 1 to 22 and the like is also one of the disclosed techniques. The encoding system 1 includes the encoding apparatus 10 and the reproduction apparatus 20. The encoding apparatus 10 includes: the input receiving unit 11 that receives an input of a plurality of pieces of point cloud data; the determination unit 122 that determines a spatial quantization value of each of the plurality of pieces of point cloud data based on at least one of a resolution and a density of each of the plurality of pieces of point cloud data an input of which has been received by the input receiving unit 11; and the encoding unit 123 that encodes each of the plurality of pieces of point cloud data based on the spatial quantization value determined by the determination unit 122. The reproduction apparatus 20 includes the request unit 222 that requests a reproduction target to be reproduced by the reproduction apparatus 20 among the plurality of pieces of point cloud data encoded by the encoding unit 123. The encoding system 1 like this can also improve the encoding efficiency as described above.

As described with reference to FIGS. 1 to 22 and the like, the determination unit 122 may determine the reproduction target among the plurality of pieces of point cloud data encoded by the encoding unit 123, based on the request from the reproduction apparatus 20. The encoding system 1 like this can appropriately switch the quality and the reproduction rate of the reproduction target in accordance with the request as described above.

As described with reference to FIGS. 1 to 22 and the like, the reproduction apparatus 20 may further include the acquisition unit 221 that acquires at least one of the communication information related to the communication between the encoding apparatus 10 and the reproduction apparatus 20, the region information related to the region in which the reproduction target requested by the reproduction apparatus 20 is reproduced, and the viewpoint information related to the viewpoint in which the reproduction target is reproduced by the reproduction apparatus 20, and the request unit 222 may request the reproduction target based on the information acquired by the acquisition unit 221 among the communication information, the region information, and the viewpoint information. This makes it possible for the encoding system 1 to request an appropriate reproduction target according to at least one of the communication information, the region information, and the viewpoint information.

As described with reference to FIGS. 1 to 22 and the like, the acquisition unit 221 may acquire the communication information, and in a case where the width of the communication band indicated by the communication information acquired by the acquisition unit 221 is a threshold or more, the request unit 222 may request a reproduction target having a smaller spatial quantization value than in a case where the width of the communication band is not the threshold or more. This makes it possible for the encoding system 1 to request an appropriate reproduction target according to the width of the communication band indicated by the communication information. For example, even when there is a fluctuation in the communication band of the network line between the encoding apparatus 10 and the reproduction apparatus 20, the encoding system 1 can request an appropriate reproduction target according to the communication band by changing the reproduction target to another reproduction target having different quality in accordance with the fluctuation of the communication band of the network link. Only in a case where the width of the communication band is a threshold or more, the encoding system 1 requests the reproduction target having a smaller spatial quantization value than in a case where the width of the communication band is not the threshold or more, thereby making it possible to save the communication band. Furthermore, in a case where the width of the communication band is longer than the threshold, the encoding system 1 can reproduce the reproduction target at a high rate.

As described with reference to FIGS. 1 to 22 and the like, the acquisition unit 221 may acquire the region information, and in a case where the region indicated by the region information acquired by the acquisition unit 221 is within the range of the Region of Interest, the request unit 222 may request the reproduction target having a smaller spatial quantization value than in a case where the region is not within the range of the Region of Interest. This makes it possible for the encoding system 1 to request an appropriate reproduction target according to the region indicated by the region information. Only in a case where the region is within the range of the Region of Interest, the encoding system 1 requests the reproduction target having a smaller spatial quantization value than in a case where the region is not within the Region of Interest, thereby making it possible to save the communication band. Furthermore, in a case where the region is not within the range of the Region of Interest, the encoding system 1 can reproduce the reproduction target at a high rate.

As described with reference to FIGS. 1 to 22 and the like, the acquisition unit 221 may acquire the viewpoint information, and in a case where the distance between the viewpoint indicated by the viewpoint information acquired by the acquisition unit 221 and the reproduction target is within a predetermined range, the request unit 222 may request the reproduction target having a smaller spatial quantization value than in a case where the distance is not within the predetermined range. This makes it possible for the encoding system 1 to request an appropriate reproduction target according to the viewpoint indicated by the viewpoint information and the distance to the reproduction target. Only in a case where the distance is within the predetermined range, the encoding system 1 requests the reproduction target having a smaller spatial quantization value than in a case where the distance is not within the predetermined range, thereby making it possible to save the communication band. Furthermore, in a case where this distance is longer than a predetermined range, the encoding system 1 can reproduce the reproduction target at a high rate.

The encoding method described with reference to drawings of FIGS. 1 to 22, etc. is also one of the disclosed technologies. The encoding method is an encoding method to be executed by the encoding apparatus 10, and includes: an input receiving step (step S1) of receiving an input of a plurality of pieces of point cloud data; a determination step (step S2) of determining a spatial quantization value of each of the plurality of pieces of point cloud data based on at least one of a resolution and a density of each of the plurality of pieces of point cloud data an input of which has been received by the input receiving step; and an encoding step (step S3) of encoding each of the plurality of pieces of point cloud data based on the spatial quantization value determined by the determination step. The encoding method like this can also improve the encoding efficiency as described above.

The encoding program described with reference to drawings of FIGS. 1 to 22, etc. is also one of the disclosed technologies. The encoding program causes the computer 1000, which is mounted on the encoding apparatus 10, to execute processing including: input receiving processing of receiving an input of a plurality of pieces of point cloud data; determination processing of determining a spatial quantization value of each of the plurality of pieces of point cloud data based on at least one of a resolution and a density of each of the plurality of pieces of point cloud data an input of which has been received by the input receiving processing; and encoding processing of encoding each of the plurality of pieces of point cloud data based on the spatial quantization value determined by the determination processing. The encoding program like this can also improve the encoding efficiency as described above.

The effects described in the present disclosure are merely examples and are not limited to the disclosed contents. There may be other effects.

While the embodiments of the present disclosure have been described above, the technical scope of the present disclosure is not limited to the above-described embodiments. Various modifications can be made without departing from the scope of the present disclosure, and mutually different components may be appropriately combined with each other.

Note that the present technology can be related to goal 9 “Industry, innovation, infrastructure” of the Sustainable Development Goals (SDGs) adopted at the UN summit in 2015.

Note that the present technology can also have the following configurations.

(1)

An encoding apparatus comprising:
an input receiving unit that receives an input of a plurality of pieces of point cloud data;
a determination unit that determines a spatial quantization value of each of the plurality of pieces of point cloud data based on at least one of a resolution and a density of each of the plurality of pieces of point cloud data an input of which has been received by the input receiving unit; and
an encoding unit that encodes each of the plurality of pieces of point cloud data based on the spatial quantization value determined by the determination unit.
   (2)

The encoding apparatus according to (1),
wherein the input receiving unit receives an input of the plurality of pieces of point cloud data including three-dimensional (3D) point cloud data.
   (3)

The encoding apparatus according to (1) or (2),
wherein the determination unit determines the spatial quantization value such that the higher the resolution of the point cloud data, the smaller the spatial quantization value will be.
   (4)

The encoding apparatus according to any one of (1) to (3),
wherein the determination unit determines the spatial quantization value such that the higher the density of the point cloud data, the smaller the spatial quantization value will be.
   (5)

The encoding apparatus according to any one of (1) to (4),
wherein the determination unit determines the spatial quantization value to a power of a predetermined value.
   (6)

The encoding apparatus according to (5),
wherein the determination unit determines the spatial quantization value to a power of 2.
   (7)

The encoding apparatus according to any one of (1) to (6),
wherein the determination unit determines, based on a request from a reproduction apparatus, a reproduction target to be reproduced by the reproduction apparatus, among the plurality of pieces of point cloud data encoded by the encoding unit.
   (8)

The encoding apparatus according to (1), further comprising
a dividing unit that divides each of the plurality of pieces of point cloud data into a plurality of pieces of divided point cloud data based on at least one of a space including each of the plurality of pieces of point cloud data and a resolution of each of the plurality of pieces of point cloud data,
wherein the determination unit determines the spatial quantization value of each of the plurality of pieces of divided point cloud data based on at least one of a resolution and a density of each of the plurality of pieces of divided point cloud data divided by the dividing unit, and
the encoding unit encodes each of the plurality of pieces of divided point cloud data based on the spatial quantization value of each of the plurality of pieces of divided point cloud data determined by the determination unit.
   (9)

The encoding apparatus according to (8),
wherein the dividing unit divides the space including each of the plurality of pieces of point cloud data into the plurality of divided spaces to divide each of the plurality of pieces of point cloud data into the plurality of pieces of divided point cloud data, and
the determination unit determines the spatial quantization value of the divided point cloud data having the highest resolution in each of the plurality of divided spaces divided by the dividing unit to be a same value.
   (10)

The encoding apparatus according to (8),
wherein the dividing unit divides each of the plurality of pieces of point cloud data into the plurality of pieces of divided point cloud data for each resolution level of each of the plurality of pieces of point cloud data, and
the determination unit determines the spatial quantization value of the divided point cloud data having the highest density at each resolution level, among the plurality of pieces of divided point cloud data divided for each resolution level by the dividing unit, to be a same value.
   (11)

The encoding apparatus according to (2), further comprising
a 3D sensing processing unit that detects, based on 3D point cloud data an input of which has been received by the input receiving unit, at least one of a resolution and a density of the 3D point cloud data,
wherein the determination unit determines the spatial quantization value of each of the plurality of pieces of point cloud data based on at least one of the resolution and the density of the 3D point cloud data detected by the 3D sensing processing unit.
   (12)

The encoding apparatus according to (11),
wherein the 3D sensing processing unit detects the resolution of the 3D point cloud data based on the 3D point cloud data an input of which has been received by the input receiving unit, and divides the 3D point cloud data into the plurality of pieces of divided point cloud data based on the detected resolution of the 3D point cloud data,
the determination unit determines the spatial quantization value of each of the plurality of pieces of divided point cloud data divided by the 3D sensing processing unit based on at least one of the resolution and the density of the 3D point cloud data detected by the 3D sensing processing unit, and
the encoding unit encodes each of the plurality of pieces of divided point cloud data based on the spatial quantization value of each of the plurality of pieces of divided point cloud data determined by the determination unit.
   (13)

An encoding system comprising:
an encoding apparatus; and a reproduction apparatus,
wherein the encoding apparatus includes:
an input receiving unit that receives an input of a plurality of pieces of point cloud data;
a determination unit that determines a spatial quantization value of each of the plurality of pieces of point cloud data based on at least one of a resolution and a density of each of the plurality of pieces of point cloud data an input of which has been received by the input receiving unit; and
an encoding unit that encodes each of the plurality of pieces of point cloud data based on the spatial quantization value determined by the determination unit, and
the reproduction apparatus includes
a request unit that requests a reproduction target to be reproduced by the reproduction apparatus, among the plurality of pieces of point cloud data encoded by the encoding unit.
   (14)

The encoding system according to (13),
wherein the determination unit determines, based on the request from the reproduction apparatus, the reproduction target among the plurality of pieces of point cloud data encoded by the encoding unit.
   (15)

The encoding system according to (13) or (14),
wherein the reproduction apparatus further includes an acquisition unit that acquires at least one of communication information related to communication between the encoding apparatus and the reproduction apparatus, region information related to a region in which the reproduction target requested by the reproduction apparatus is reproduced, and viewpoint information related to a viewpoint in which the reproduction target is reproduced by the reproduction apparatus, and
the request unit requests the reproduction target based on the information acquired by the acquisition unit, among the communication information, the region information, and the viewpoint information.
   (16)

The encoding system according to (15),
wherein the acquisition unit acquires the communication information, and
in a case where a width of a communication band indicated by the communication information acquired by the acquisition unit is a threshold or more, the request unit requests the reproduction target having the smaller spatial quantization value than in a case where the width of the communication band is not the threshold or more.
   (17)

The encoding system according to (15),
wherein the acquisition unit acquires the region information, and
in a case where the region indicated by the region information acquired by the acquisition unit is within the range of a Region of Interest, the request unit requests the reproduction target having the smaller spatial quantization value than in a case where the region is not within the range of the Region of Interest.
   (18)

The encoding system according to (15),
wherein the acquisition unit acquires the viewpoint information, and
in a case where the a distance between a viewpoint indicated by the viewpoint information acquired by the acquisition unit is within a predetermined range, the request unit requests the reproduction target having the smaller spatial quantization value than in a case where the distance is not within the predetermined range.
   (19)

An encoding method to be executed by an encoding apparatus, the encoding method comprising:
an input receiving step of receiving an input of a plurality of pieces of point cloud data;
a determination step of determining a spatial quantization value of each of the plurality of pieces of point cloud data based on at least one of a resolution and a density of each of the plurality of pieces of point cloud data an input of which has been received by the input receiving step; and
an encoding step of encoding each of the plurality of pieces of point cloud data based on the spatial quantization value determined by the determination step.
   (20)

An encoding program causing a computer mounted on an encoding apparatus to execute:
input receiving processing of receiving an input of a plurality of pieces of point cloud data;
determination processing of determining a spatial quantization value of each of the plurality of pieces of point cloud data based on at least one of a resolution and a density of each of the plurality of pieces of point cloud data an input of which has been received by the input receiving processing; and
encoding processing of encoding each of the plurality of pieces of point cloud data based on the spatial quantization value determined by the determination processing.

### REFERENCE SIGNS LIST

1 ENCODING SYSTEM
10 ENCODING APPARATUS
11 INPUT RECEIVING UNIT
12, 22 CONTROL UNIT
13, 23 STORAGE UNIT
14, 21 COMMUNICATION UNIT
20 REPRODUCTION APPARATUS
121 DIVIDING UNIT
122 DETERMINATION UNIT
123 ENCODING UNIT
221 ACQUISITION UNIT
222 REQUEST UNIT
223 REPRODUCTION UNIT

1. An encoding apparatus comprising:
an input receiving unit that receives an input of a plurality of pieces of point cloud data;
a determination unit that determines a spatial quantization value of each of the plurality of pieces of point cloud data based on at least one of a resolution and a density of each of the plurality of pieces of point cloud data an input of which has been received by the input receiving unit; and
an encoding unit that encodes each of the plurality of pieces of point cloud data based on the spatial quantization value determined by the determination unit.

2. The encoding apparatus according to claim 1,
wherein the input receiving unit receives an input of the plurality of pieces of point cloud data including three-dimensional (3D) point cloud data.

3. The encoding apparatus according to claim 1,
wherein the determination unit determines the spatial quantization value such that the higher the resolution of the point cloud data, the smaller the spatial quantization value will be.

4. The encoding apparatus according to claim 1,
wherein the determination unit determines the spatial quantization value such that the higher the density of the point cloud data, the smaller the spatial quantization value will be.

5. The encoding apparatus according to claim 1,
wherein the determination unit determines the spatial quantization value to a power of a predetermined value.

6. The encoding apparatus according to claim 5,
wherein the determination unit determines the spatial quantization value to a power of 2.

7. The encoding apparatus according to claim 1,
wherein the determination unit determines, based on a request from a reproduction apparatus, a reproduction target to be reproduced by the reproduction apparatus, among the plurality of pieces of point cloud data encoded by the encoding unit.

8. The encoding apparatus according to claim 1, further comprising
a dividing unit that divides each of the plurality of pieces of point cloud data into a plurality of pieces of divided point cloud data based on at least one of a space including each of the plurality of pieces of point cloud data and a resolution of each of the plurality of pieces of point cloud data,
wherein the determination unit determines the spatial quantization value of each of the plurality of pieces of divided point cloud data based on at least one of a resolution and a density of each of the plurality of pieces of divided point cloud data divided by the dividing unit, and
the encoding unit encodes each of the plurality of pieces of divided point cloud data based on the spatial quantization value of each of the plurality of pieces of divided point cloud data determined by the determination unit.

9. The encoding apparatus according to claim 8,
wherein the dividing unit divides the space including each of the plurality of pieces of point cloud data into the plurality of divided spaces to divide each of the plurality of pieces of point cloud data into the plurality of pieces of divided point cloud data, and
the determination unit determines the spatial quantization value of the divided point cloud data having the highest resolution in each of the plurality of divided spaces divided by the dividing unit to be a same value.

10. The encoding apparatus according to claim 8,
wherein the dividing unit divides each of the plurality of pieces of point cloud data into the plurality of pieces of divided point cloud data for each resolution level of each of the plurality of pieces of point cloud data, and
the determination unit determines the spatial quantization value of the divided point cloud data having the highest density at each resolution level, among the plurality of pieces of divided point cloud data divided for each resolution level by the dividing unit, to be a same value.

11. The encoding apparatus according to claim 2, further comprising
a 3D sensing processing unit that detects, based on 3D point cloud data an input of which has been received by the input receiving unit, at least one of a resolution and a density of the 3D point cloud data,
wherein the determination unit determines the spatial quantization value of each of the plurality of pieces of point cloud data based on at least one of the resolution and the density of the 3D point cloud data detected by the 3D sensing processing unit.

12. The encoding apparatus according to claim 11,
wherein the 3D sensing processing unit detects the resolution of the 3D point cloud data based on the 3D point cloud data an input of which has been received by the input receiving unit, and divides the 3D point cloud data into the plurality of pieces of divided point cloud data based on the detected resolution of the 3D point cloud data,
the determination unit determines the spatial quantization value of each of the plurality of pieces of divided point cloud data divided by the 3D sensing processing unit based on at least one of the resolution and the density of the 3D point cloud data detected by the 3D sensing processing unit, and
the encoding unit encodes each of the plurality of pieces of divided point cloud data based on the spatial quantization value of each of the plurality of pieces of divided point cloud data determined by the determination unit.

13. An encoding system comprising:
an encoding apparatus; and a reproduction apparatus,
wherein the encoding apparatus includes:
an input receiving unit that receives an input of a plurality of pieces of point cloud data;
a determination unit that determines a spatial quantization value of each of the plurality of pieces of point cloud data based on at least one of a resolution and a density of each of the plurality of pieces of point cloud data an input of which has been received by the input receiving unit; and
an encoding unit that encodes each of the plurality of pieces of point cloud data based on the spatial quantization value determined by the determination unit, and
the reproduction apparatus includes
a request unit that requests a reproduction target to be reproduced by the reproduction apparatus, among the plurality of pieces of point cloud data encoded by the encoding unit.

14. The encoding system according to claim 13,
wherein the determination unit determines, based on the request from the reproduction apparatus, the reproduction target among the plurality of pieces of point cloud data encoded by the encoding unit.

15. The encoding system according to claim 13,
wherein the reproduction apparatus further includes an acquisition unit that acquires at least one of communication information related to communication between the encoding apparatus and the reproduction apparatus, region information related to a region in which the reproduction target requested by the reproduction apparatus is reproduced, and viewpoint information related to a viewpoint in which the reproduction target is reproduced by the reproduction apparatus, and
the request unit requests the reproduction target based on the information acquired by the acquisition unit, among the communication information, the region information, and the viewpoint information.

16. The encoding system according to claim 15,
wherein the acquisition unit acquires the communication information, and
in a case where a width of a communication band indicated by the communication information acquired by the acquisition unit is a threshold or more, the request unit requests the reproduction target having the smaller spatial quantization value than in a case where the width of the communication band is not the threshold or more.

17. The encoding system according to claim 15,
wherein the acquisition unit acquires the region information, and
in a case where the region indicated by the region information acquired by the acquisition unit is within the range of a Region of Interest, the request unit requests the reproduction target having the smaller spatial quantization value than in a case where the region is not within the range of the Region of Interest.

18. The encoding system according to claim 15,
wherein the acquisition unit acquires the viewpoint information, and
in a case where the a distance between a viewpoint indicated by the viewpoint information acquired by the acquisition unit is within a predetermined range, the request unit requests the reproduction target having the smaller spatial quantization value than in a case where the distance is not within the predetermined range.

19. An encoding method to be executed by an encoding apparatus, the encoding method comprising:
an input receiving step of receiving an input of a plurality of pieces of point cloud data;
a determination step of determining a spatial quantization value of each of the plurality of pieces of point cloud data based on at least one of a resolution and a density of each of the plurality of pieces of point cloud data an input of which has been received by the input receiving step; and
an encoding step of encoding each of the plurality of pieces of point cloud data based on the spatial quantization value determined by the determination step.

20. An encoding program causing a computer mounted on an encoding apparatus to execute:
input receiving processing of receiving an input of a plurality of pieces of point cloud data;
determination processing of determining a spatial quantization value of each of the plurality of pieces of point cloud data based on at least one of a resolution and a density of each of the plurality of pieces of point cloud data an input of which has been received by the input receiving processing; and
encoding processing of encoding each of the plurality of pieces of point cloud data based on the spatial quantization value determined by the determination processing.
